(19) United States
(12) Patent Application Publication
(10) Pub. No.: US 2003/0035364 A1
(43) Pub. Date: Feb. 20, 2003

(54) Optically readable carrier and an adapter therefor

(76) Inventor: King Yeung Choi, Hong Kong (HK)

Correspondence Address: ENCORE HOLDINGS LIMITED, 1180 Avenue of the Americas, New York, NY, 10036-8403, US

(21) Appl. No.: 09/741,518

(22) Filed: Dec. 19, 2000

(30) Foreign Application Priority Data
Oct. 23, 2000 (GB) 0025897.0

(51) Int. Cl. G11B 3/70; G11B 5/84; G11B 7/26

(52) U.S. Cl. 369/289

(57) ABSTRACT

CDs, CD-ROMs, DVDs, optical discs or the like, referred to herein as optically readable carriers, and an adapter therefor, for adapting said optically readable carriers, which may he non-round, for use in a CD, CD-ROM, DVD, optical disc or the like reader, writer or other optically readable carrier handling device.

“Smart cards” made from optically readable carriers.

The present invention relates to CDs, CD-ROMs. DVDs, optical discs or the like, referred to herein as optically readable carriers, and an adapter therefor, in particular one for adapting said optically readable carriers, which may be non-round, for use in a CD, CD-ROM, DVD, optical disc or the like reader, writer or other optically readable carrier handling device. The invention also relates to “smart cards” made from optically readable carriers.

A conventional optically readable carrier is round in shape. Typically the optically readable carriers are approximately 120 or 80 mm in diameter. Trays of, for example, CD players or CD-ROM drives on which CD or CD-ROMs are placed for rotation often have wells or slots, for example, depressions, mounts or grooves; which provide a location for accepting the optically readable carriers. Usually these wells or slots are generally circular and are proportioned/spaced so that they are suitable for putting therein one of either a 120 mm CD (a conventional CT) or an 80 mm CD (known as a mini CD or a CD single).

Recently, however, non-round CDs have been being produced, for example for promotional use.

The teaching or a first type of such a CD can be found in German patent application number DE19607565. This document teaches a CD that has a round shape initially. However, sectors can be snapped off to form a non-round CD. In order to stabilise rotation of the non-round CD in a drive tray, at least three outermost points of the CD are retained from the edge of the formerly round CD, such that they will locate the CD within the well or slot of the drive tray, be that either of 120 mm or 80 mm diameter. This prevents the CD from easily jumping around or out of the well or slot FIG. 1 shows such a carrier.

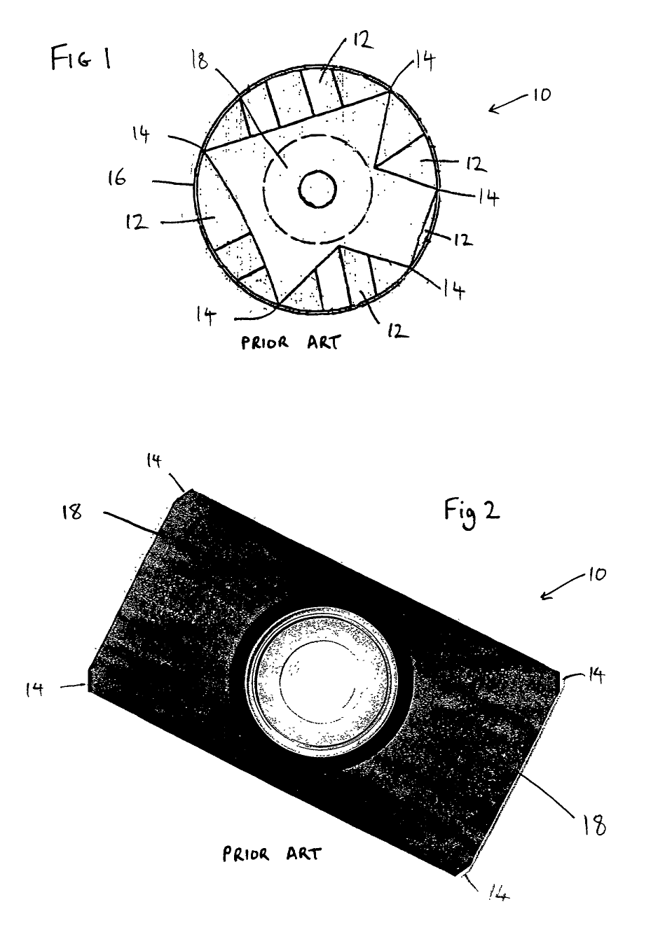

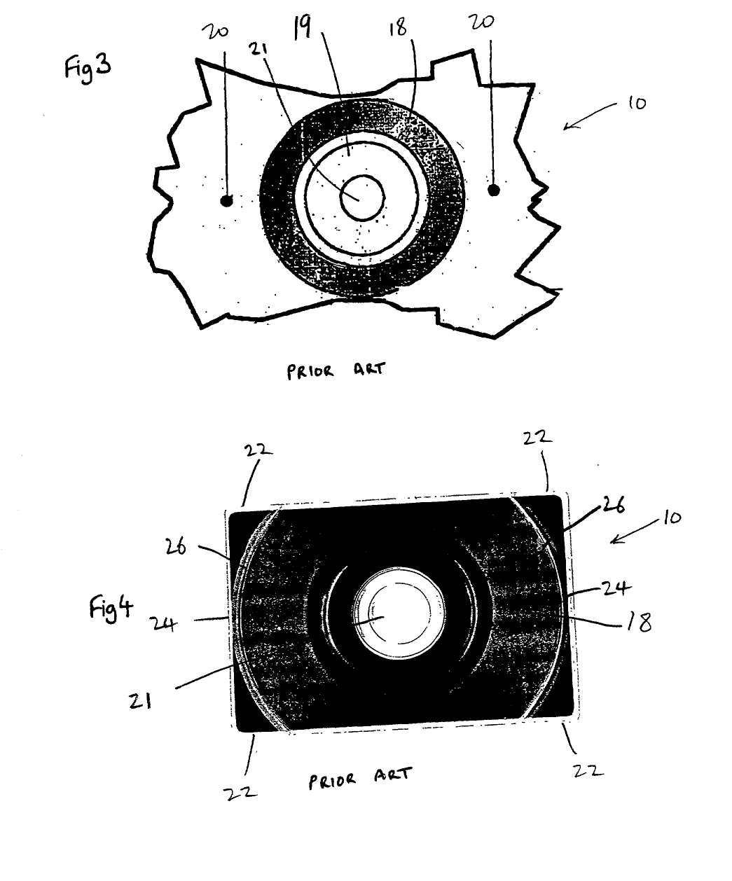

FIG. 2 shows a second example of this type of CD, in a rectangular shape, in which four short circumferential arcs are retained as the corners of the rectangular shaped CD, the sides having been cut straight. The CD has appropriate diagonal dimensions, therefore, so that the CD will lie in the correct position within the slot of a tray (the CDs diagonal dimensions are approximately 120 mm).

A problem with a carrier of this type is that they are noisy when used in a high speed drives due to the non circular shape thereof (spinning a circular disc is quiet, whereas a spinning rod is noisy!). Also, an unbalanced disc, when spinning at high speed, would damage the drive or the laser head of the drive.

A second type of promotional CD is described in Hong Kong short-term parent number HK1008469. The Hong Kong short-term parent describes the use of knobs (or protrusions) on the underside of the CD (see FIG. 3). These knobs are positioned to correspond with a slot of a drive tray so that they act as locating means for fining within the 80 mm diameter slot of the tray. FIG. 4 shows a variant of this type of promotional CD in which the corners (and two edges) of the CD are rebated to leave arcuate returned edges for locating in the slot.

A further problem of carriers of the above two types is that they are not convenient either to store or to carry. The first two examples are not of conventional shape. Storage in CD boxes would usually be required. The second two examples are either not stackable due to the knobs, or they are easy to damage; the rebated corners can easily snap off.

It would therefore be desirable to provide an alternative means for stabilising the rotation of a non-round optically readable carrier in, for example, a CD drive without the need for the carrier to be limited to having either appropriately positioned corners, appropriate diagonal dimensions or knobs and/or arcuate returned edges, such as required by the prior art.

It would also be desirable to provide a new carrier form that is convenient both to store and to carry.

According to the first aspect of the present invention there is provided an adapter for a non-round optically readable carrier, the adapter comprising a ledge formation adapted to seat the optically readable carrier, whereby, in use, a non-round optically readable carrier is retained in a seated position on the ledge formation.

A non-round, functional surface may be provided for abutting the edge of the carrier or part thereof.

The functional formation may be sized to retain the carrier by means of an engagement fit.

The adapter may be provided with one or more retaining means for retaining the carrier on the ledge formation. Preferably the retaining means is one or more resilient clamping means, for example a resilient clip.

Preferably the adapter comprises a planar member having an edge thickness and outermost diameter in accordance with a conventional round optically readable carrier. However, the adapter may be otherwise shaped. For example, the adapter may have a non-round shape but with either appropriately positioned corners, appropriate diagonal dimensions or knobs/arcuate returned edges as discussed above.

Preferably, the adapter is for a rectangular optically readable carrier. Most preferably the adapter is for a credit card shaped optically readable carrier.

Preferably, the adapter is for two or more different sizes and/or shapes of optically readable carrier.

Preferably the adapter comprises two or more sets of retaining means, the first set adapted to retain an optically readable carrier of one size and the other set adapted to retain an optically readable carrier of a second size.

The two separate sets of retaining means may have their own associated ledge formations.

The adapter may be provided with a well for accepting the optically readable carrier therein. Preferably the well is generally cross-shaped, the cross being defined by two superimposed, orthogonally arranged, different sized and/or shaped, rectangles. The well provides a means to carry one of two different sized and/or shaped optically readable carriers.

The ledge formation may be offset from a central point of the adapter to allow a carrier having its optically readable surface not centrally positioned thereon to be retained, in use, on the adapter such that the optically readable surface is centrally positioned on the adapter.

The adapter may be provided with a counterbalancing means such that its centre of mass is positioned away from the centre of rotation thereof. This allows an optically readable carrier having its centre of mass positioned away from the centre of the optically readable portion of the carrier to be retained, in use, on the adapter with the combined centre of mass (of the combined adapter and carrier) being positioned at the centre of rotation of the adapter and carrier.

According to a second aspect of the present invention there is provided a non-round, substantially flat, optically readable carrier. Both sides of the carrier should be substantially smooth, without grooves, knobs or the like, other than a spindle aperture and the clamping area. The corners or sides, thereof may be rounded, but are not defined by co-arcuate arcs, i.e. arcs defining distinct circumferential parts of the same circle.

Preferably the optically readable surface (or surfaces if double sided) extends substantially to at least two edges of the carrier. Preferably, the carrier is of a size having no part thereof, on either a face or an edge thereof suitable for, in use, fitting within a slot of a tray of a drive for stabilising the carrier within the tray.

Preferably, the optically readable carrier is substantially rectangular.

Preferably the carrier is credit card shaped or sized, i.e. about 1.2 mm thick, 85.6 mm long and 54 mm wide.

Alternatively, the carrier may be an elongated credit card shape, preferably about 1.2 mm thick, 95 mm long and 54 mm wide. The longer length, although not essential, provides a larger space for filling a smart card chip to the card; a hole (for a CD player's spindle) and a clamping area (preferably in the centre of the card), as found in conventional CDs, fill a large portion of the card that might conventionally be used, with normal credit cards, for the fitting of a smart card chip thereon.

The clamping area may be off-set from the middle of the carrier. Thereby the carrier might have a centre of mass positioned away from the centre of the optically readable portion thereof A counterbalance means may be provided in or on the carrier to realign the centre of mass of the carrier with the centre of the optically readable portion thereof.

Preferably the carrier is also a credit or debit card.

According to a third aspect of the present invention, there is provided an optically readable carrier incorporating non-optical means for interacting with a further apparatus.

Preferably, the non-optical means is either a magnetic strip or a smart card chip embedded therein, or both. The smart card chip may be of the contact type or the non-contact type.

The carrier may have an optically readable area having a first thickness and a smart card area of a second thickness, the smart card area having fitted therein or thereon a smart card chip of the contact type. The smart card area may have a thickness of about 0.8 mm for fitting into a smart card reader. The optically readable area may have a thickness of 1.2 or 1.4 mm for use in a CD or DVD reader, respectively.

However, the carrier of the third aspect of the present invention may be in accordance with the second aspect of the present invention.

The carrier of the third aspect of the present invention may comprise any preferred or optional characteristic of the second aspect of the present invention, and vice versa.

Preferably, the carrier of the second or third aspect of the present invention fits in the adapter of the first aspect of the present invention.

The various aspects of the present invention will now be described with reference to the accompanying drawings in which:

FIG. 1 shows a prior art non-round CD disclosed in German patent application number E19607565;

FIG. 2 shows a prior art variant of the CD type of FIG. 1;

FIG. 3 shows a prior an non-round CD disclosed in Hong Kong short-term patent number HK1008469;

FIG. 4 shows a prior art variant of the CD type of FIG. 2;

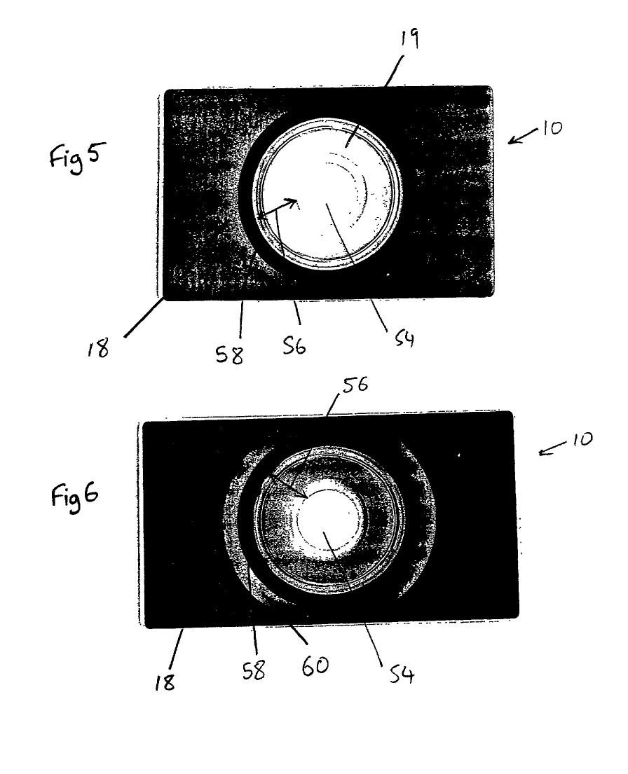

FIG. 5 shows an optically readable carrier in accordance with the second and third aspect of the present invention;

FIG. 6 shows an alternative optically readable carrier in accordance with the second and third aspect of the present invention;

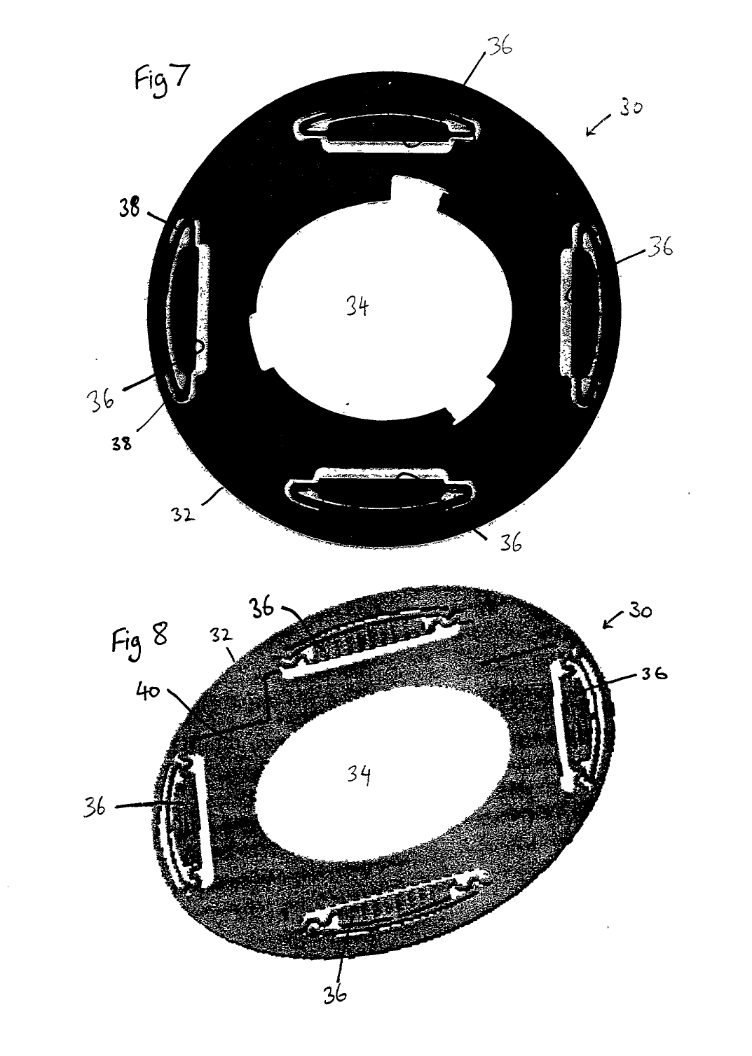

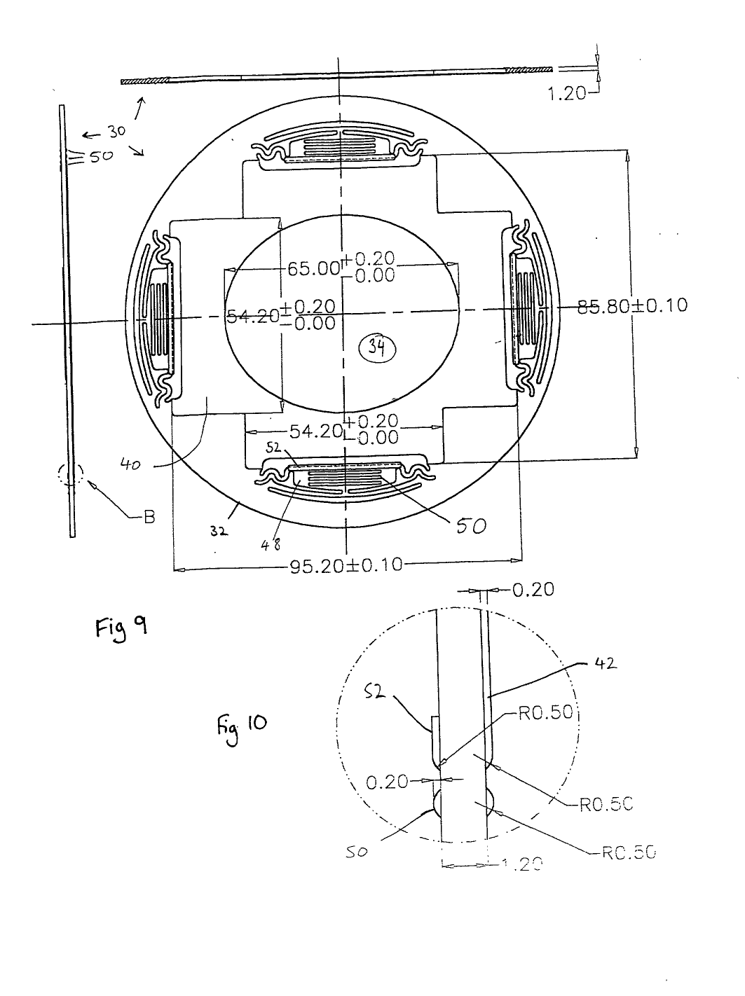

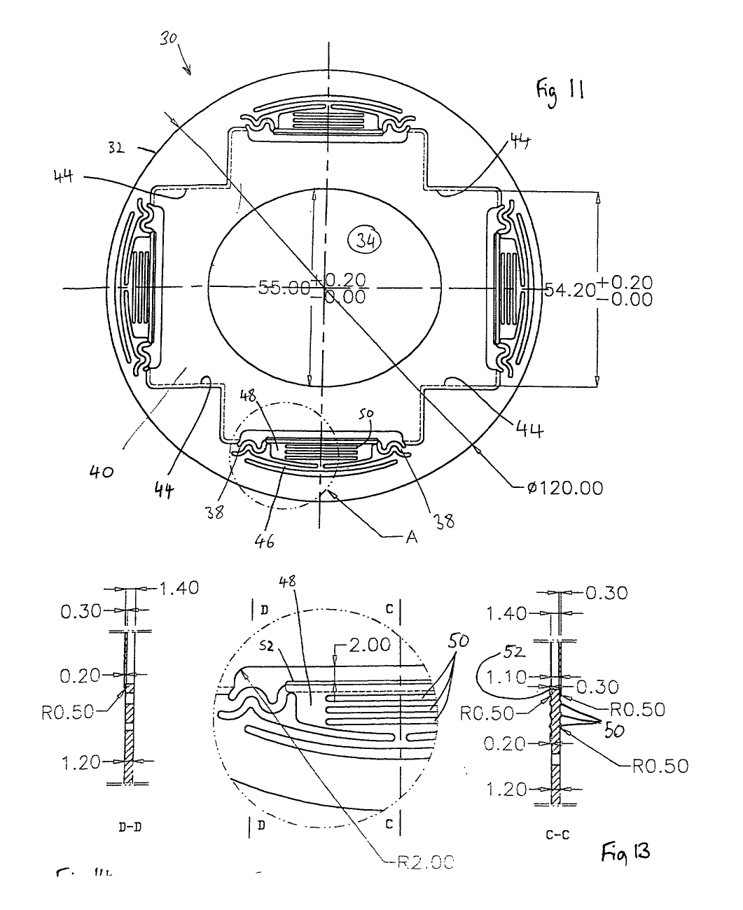

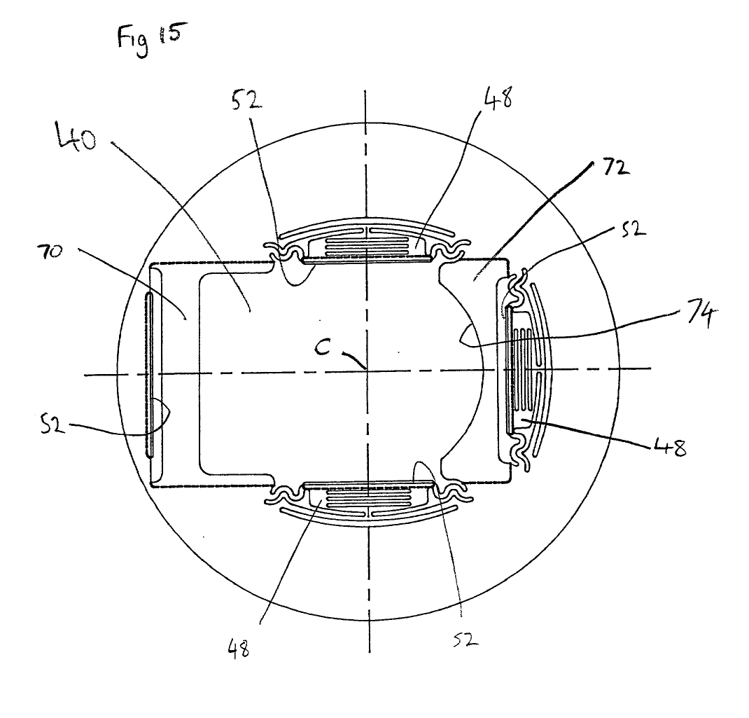

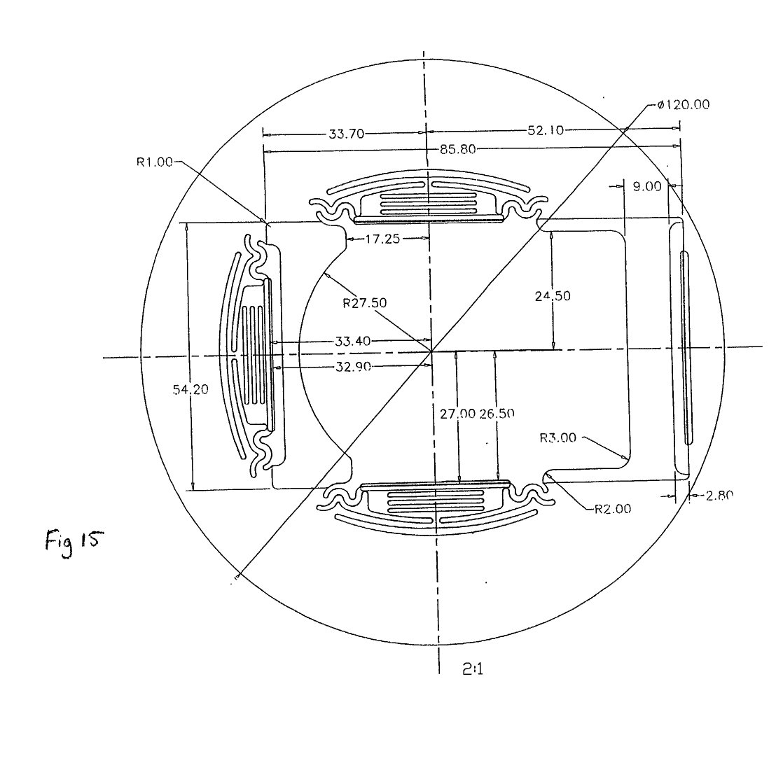

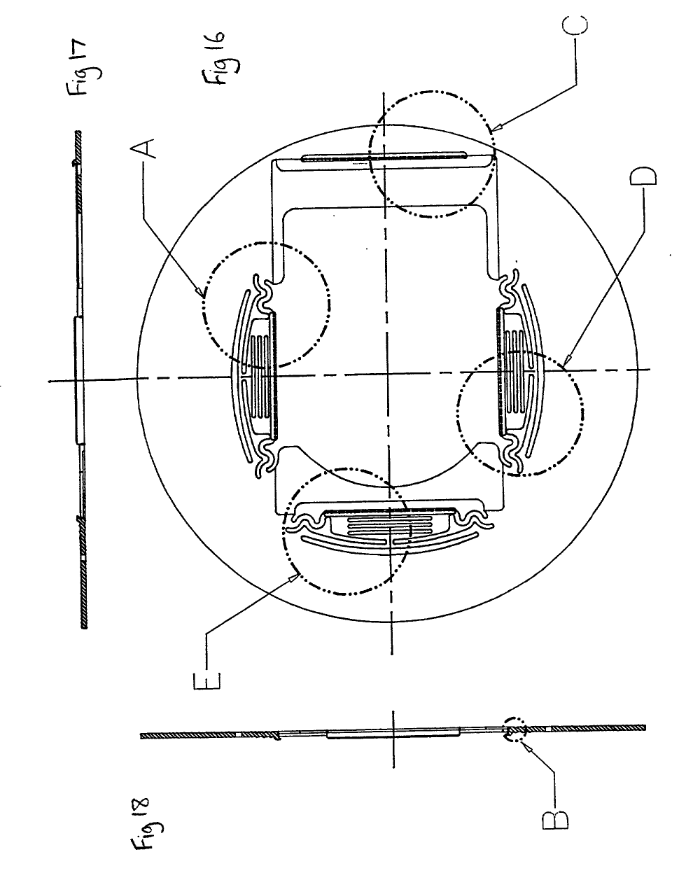

FIG. 7 shows a first embodiment of an adapter in accordance with the first aspect of the present invention;

FIG. 8 is a perspective view of a second embodiment of an adapter in accordance with the first aspect of the present invention;

FIG. 9 is an orthographic projection of the adapter of FIG. 8;

FIG. 10 is an enlarged view B from FIG. 9;

FIG. 11 is a rear view of the adapter of FIG. 9;

FIG. 12 is an enlarged view A from FIG. 11;

FIGS. 13 and 14 are sections C-C and D-D, respectively, from FIG. 12,

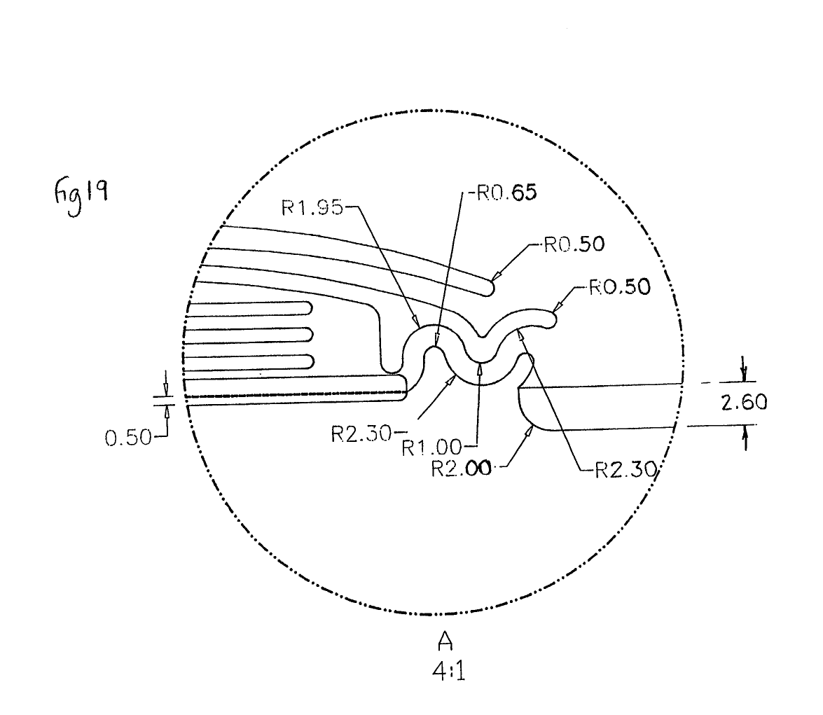

FIGS. 15 and 15′ are top and bottom plan views of a third embodiment of an adapter in accordance with the first aspect of the present invention;

FIGS. 16, 17 and 18 are an orthographic projection of the adapter shown in FIG. 15;

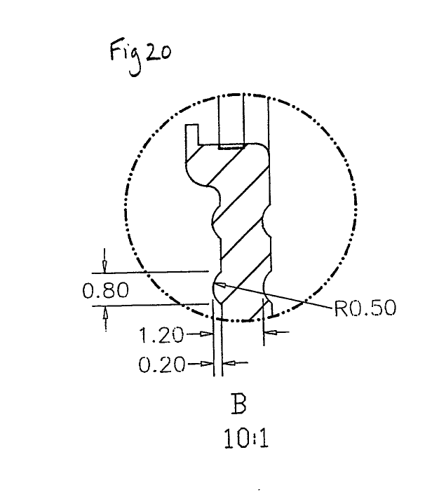

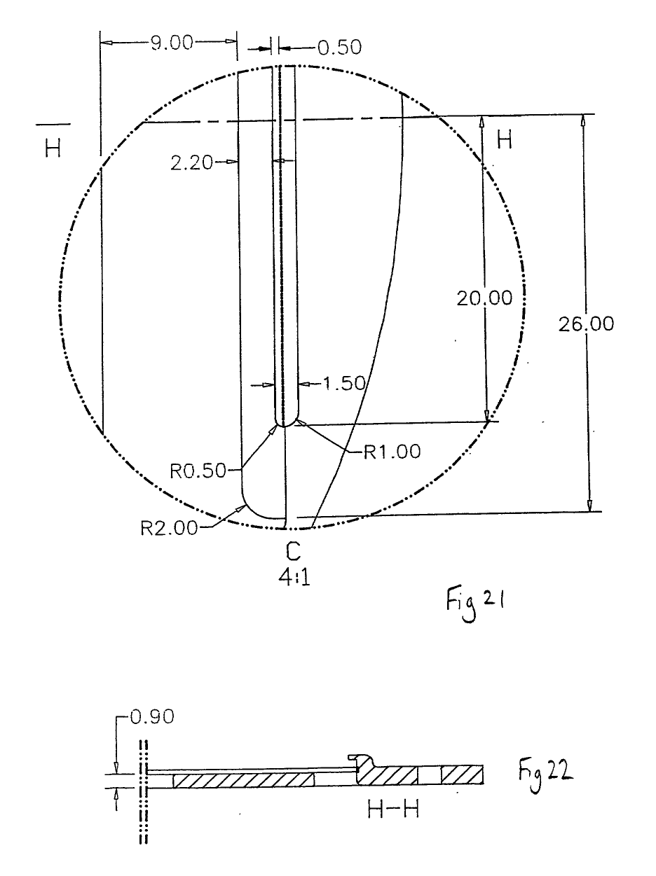

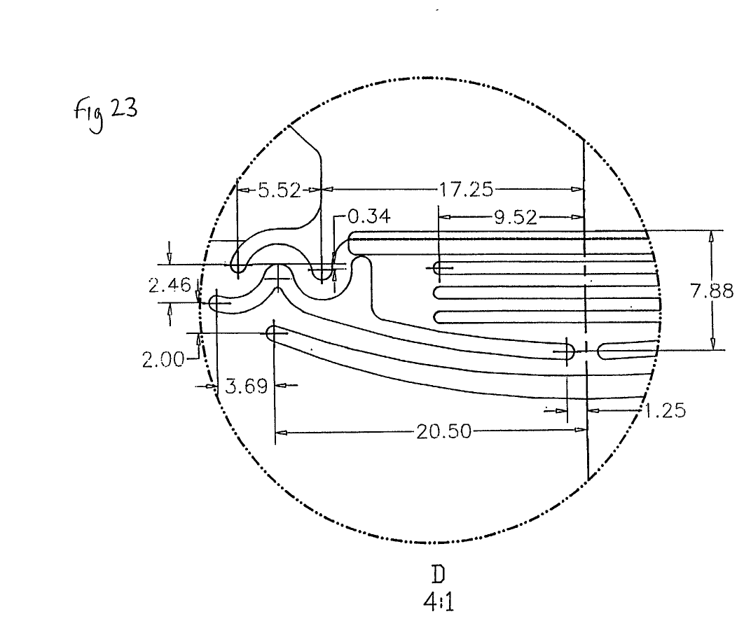

FIGS. 19, 20, 21, 23 and 24 are enlarged views A, B, C, D and E taken from FIGS. 16 and 18;

FIG. 22 is a section H-H through FIG. 21;

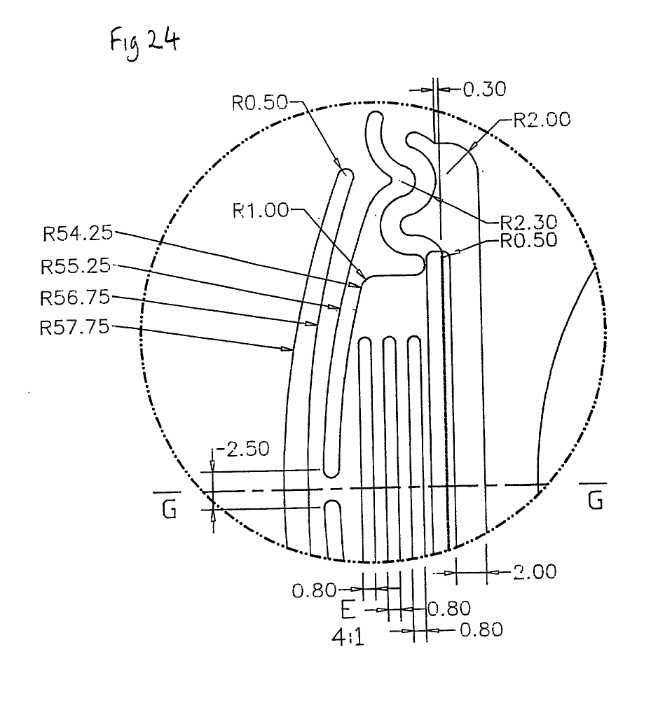

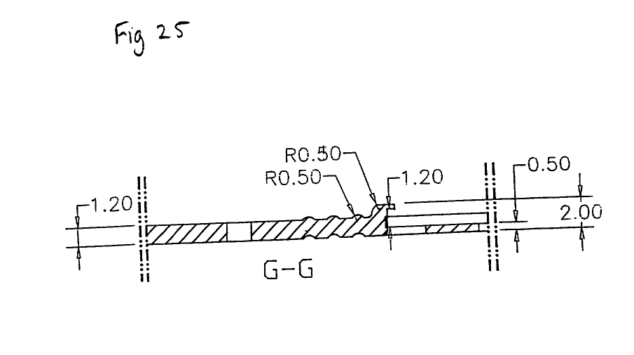

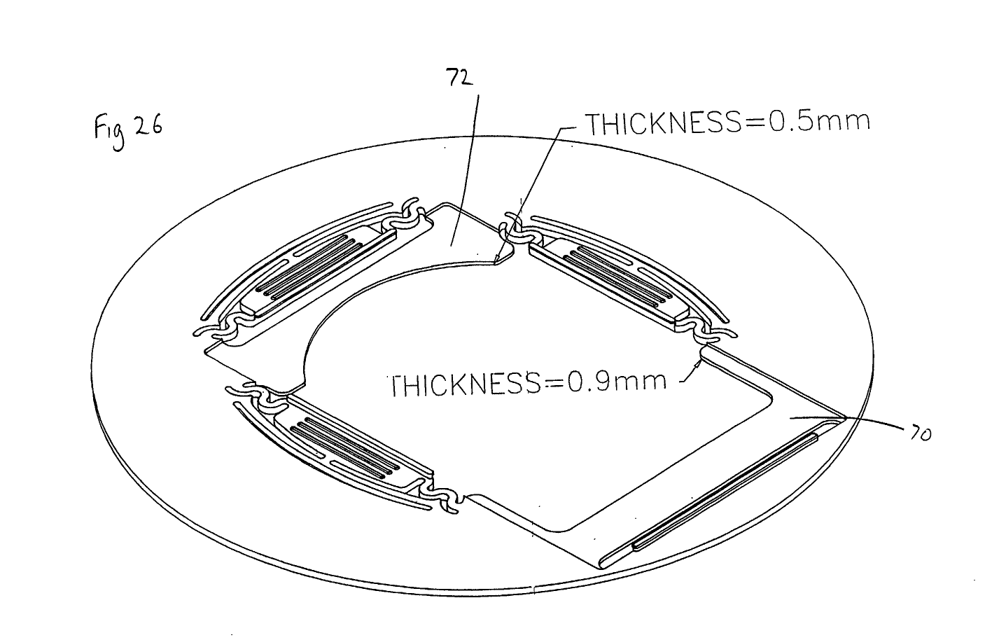

FIG. 25 is a section G-G through FIG. 24;

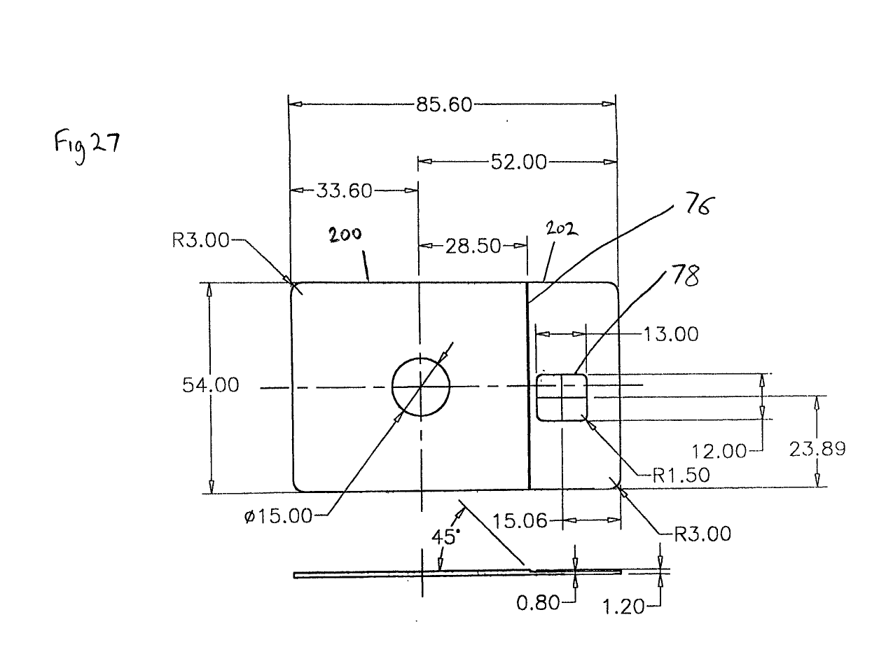

FIG. 26 is a perspective view of the adapter of FIG. 15;

FIG. 27 is an optically readable carrier in the form of a CD having a smart card incorporated in an optically readable side thereof;

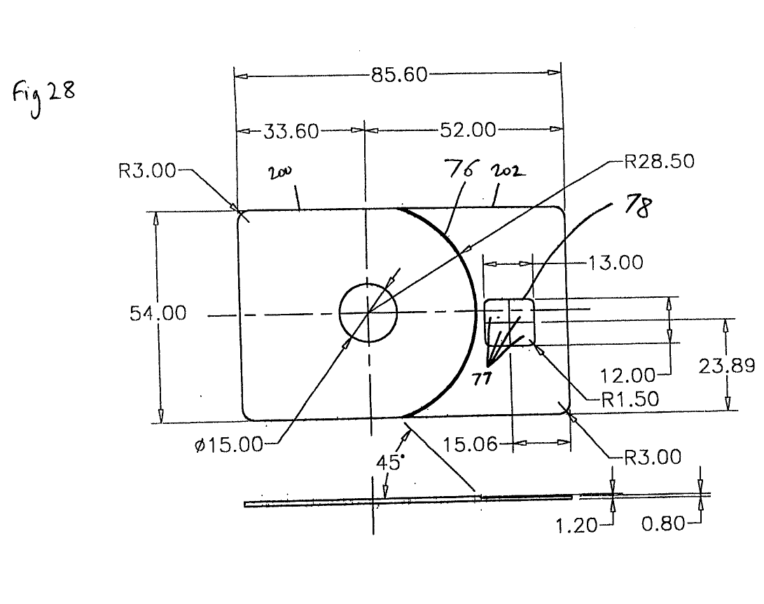

FIG. 28 is an alternative optically readable carrier in the form of a CD having a smart card incorporated therein;

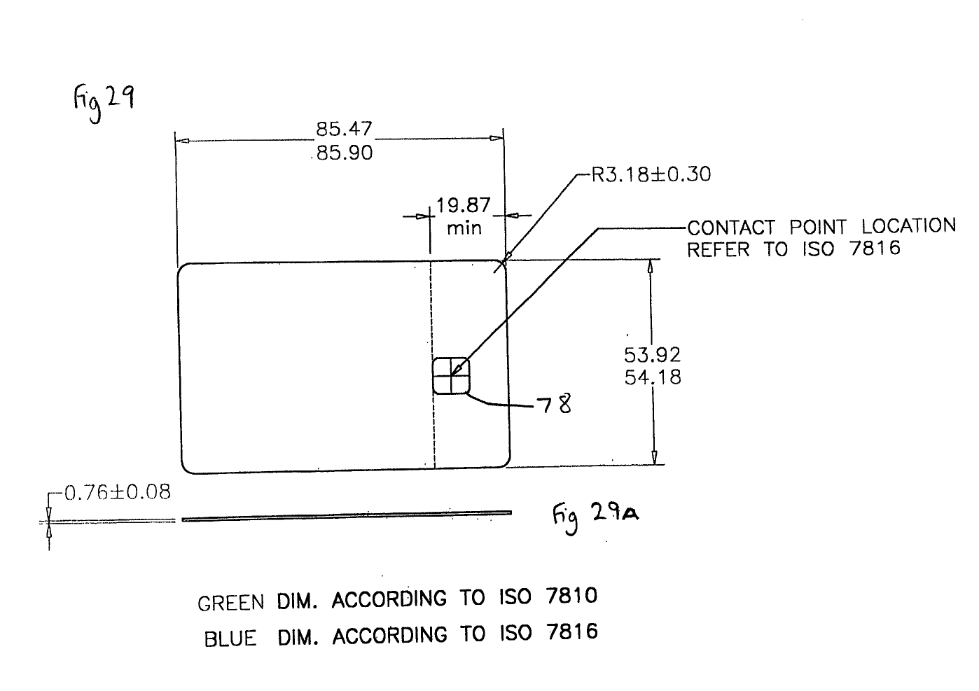

FIG. 29 is a prior at smart card in accordance with the dimensions required by International Standards;

FIG. 29A is a side elevation of the card of FIG. 29;

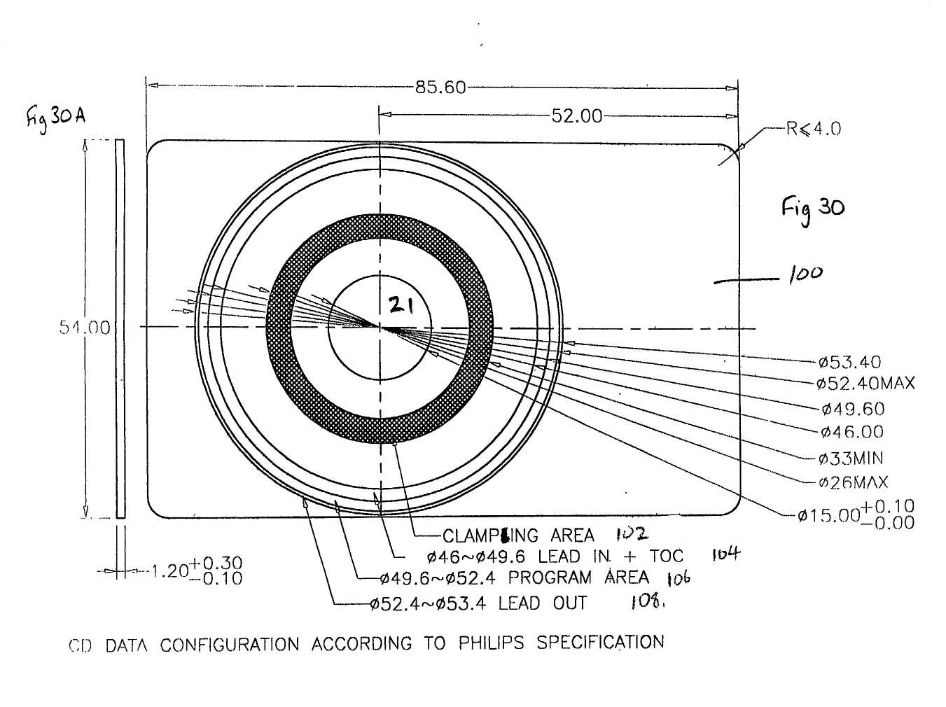

FIG. 30 is a credit card sized CD having an offset clamping area;

FIG. 30A is a side elevation of the CD of FIG. 30;

FIG. 31 shows a stamper and mold assembly used in a first step in forming carriers in accordance with the third aspect of the present invention;

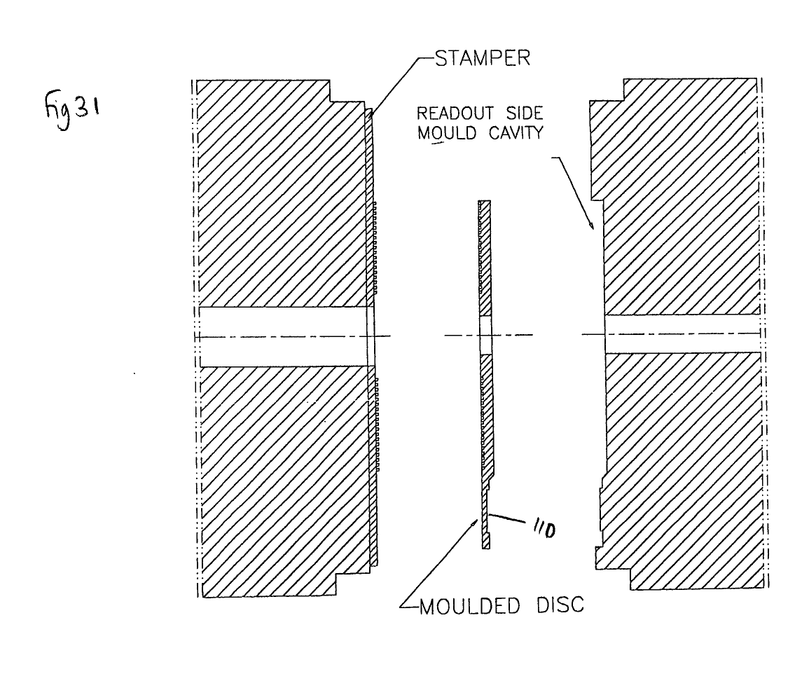

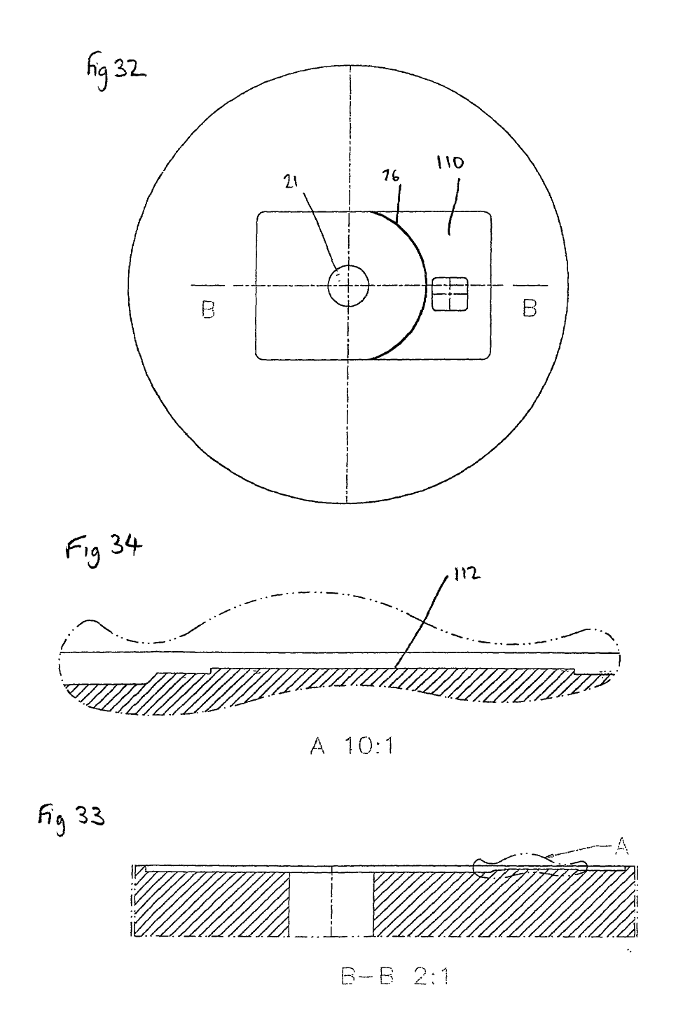

FIGS. 32 to 34 show the mold in plan and enlarged sections;

FIG. 35 shows an alternative stamper and mold assembly used in a first step in forming carriers in accordance with the third aspect of the present invention;

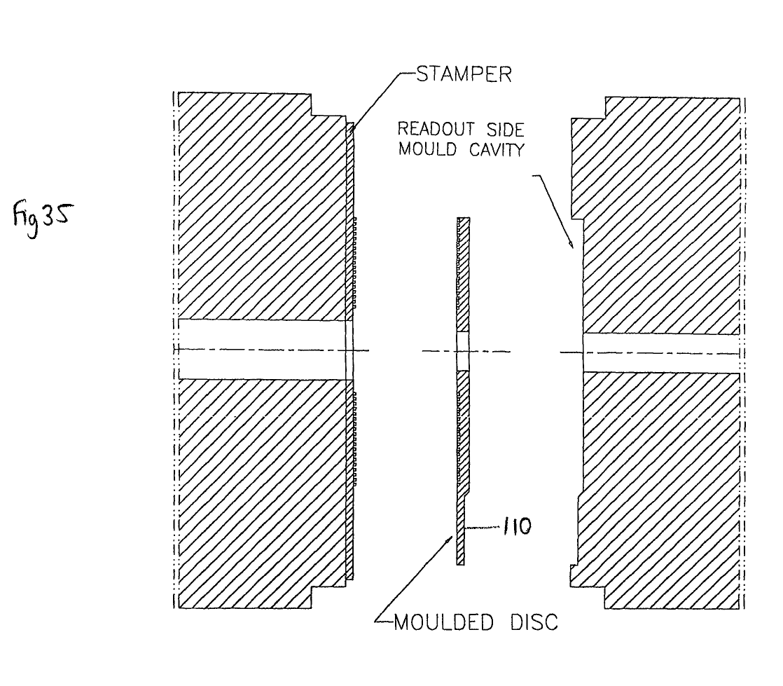

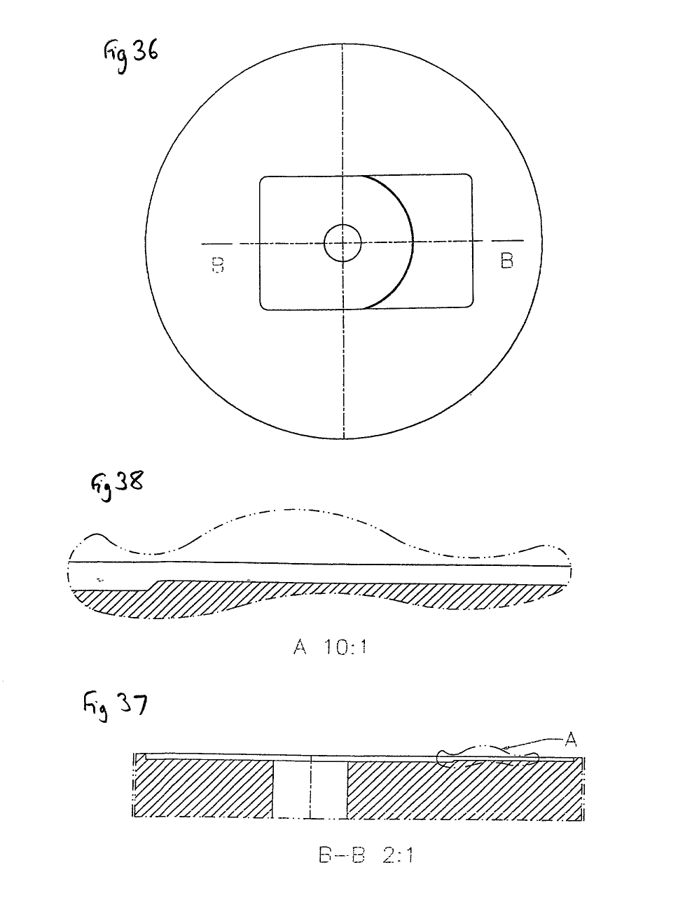

FIGS. 36 to 38 show the mold of second method in plan and enlarged sections,

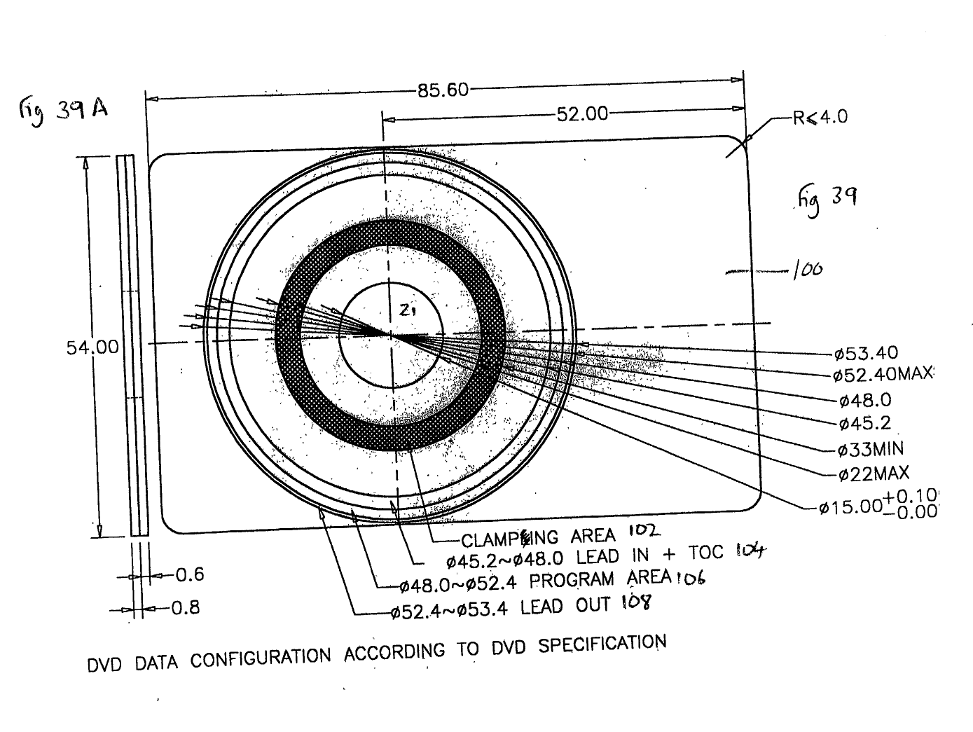

FIG. 39 shows a DVD with an off-set clamping area,

FIG. 39A shows a side elevation of the DVD of FIG. 39;

FIG. 40 shows a smart card DVD in accordance with the third aspect of the present invention;

FIG. 40A shows a side elevation of the smart card DVD of FIG. 40;

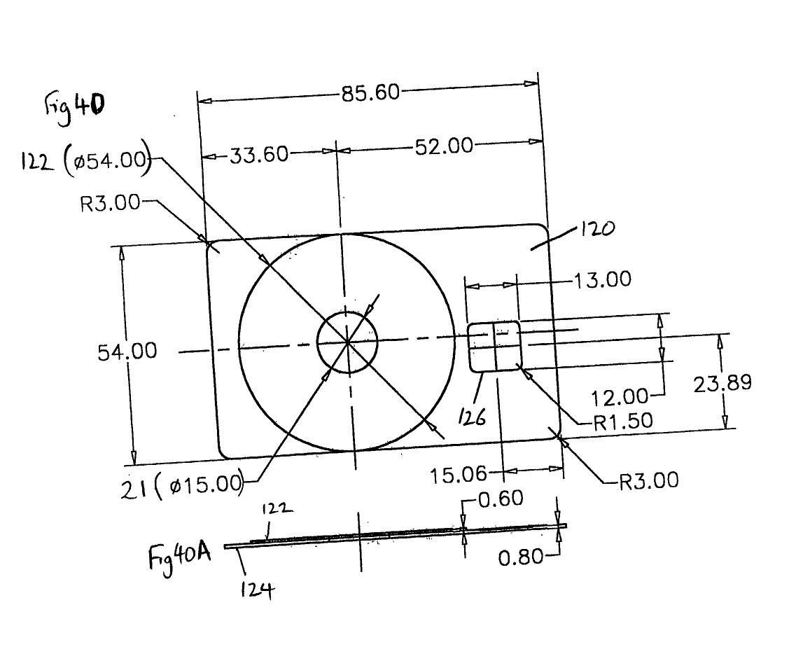

FIG. 41 shows a first method of forming the smart card DVD of FIG. 40;

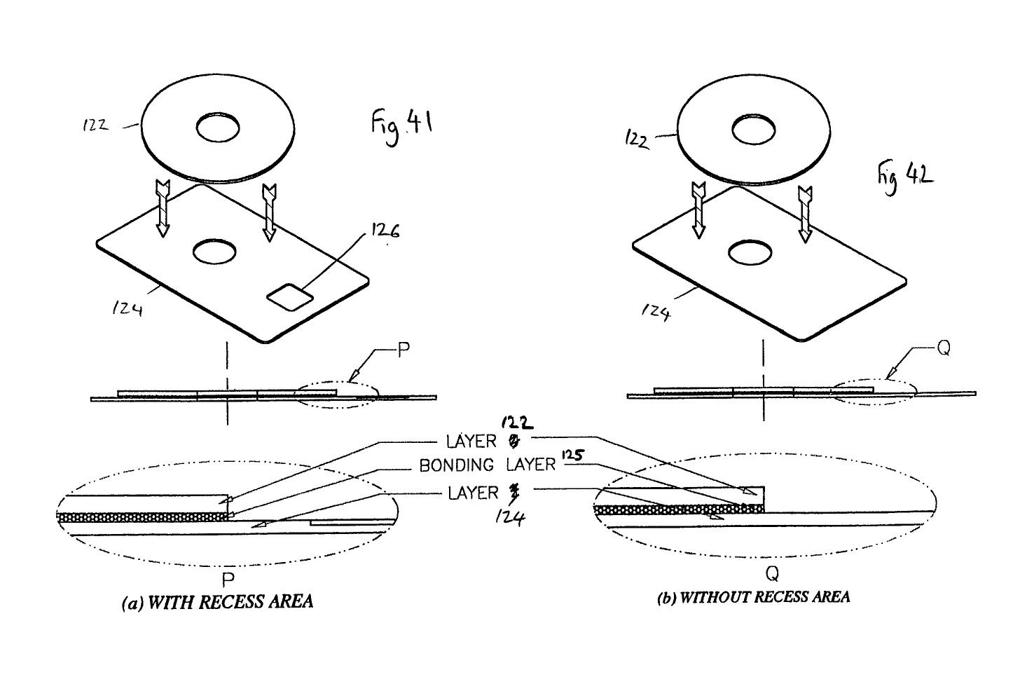

FIG. 42 shows a stage in a second method of forming an alternative smart card DVD;

FIG. 43 shows a plan view of a mold for forming a DVD disc layer of the DVD of FIG.

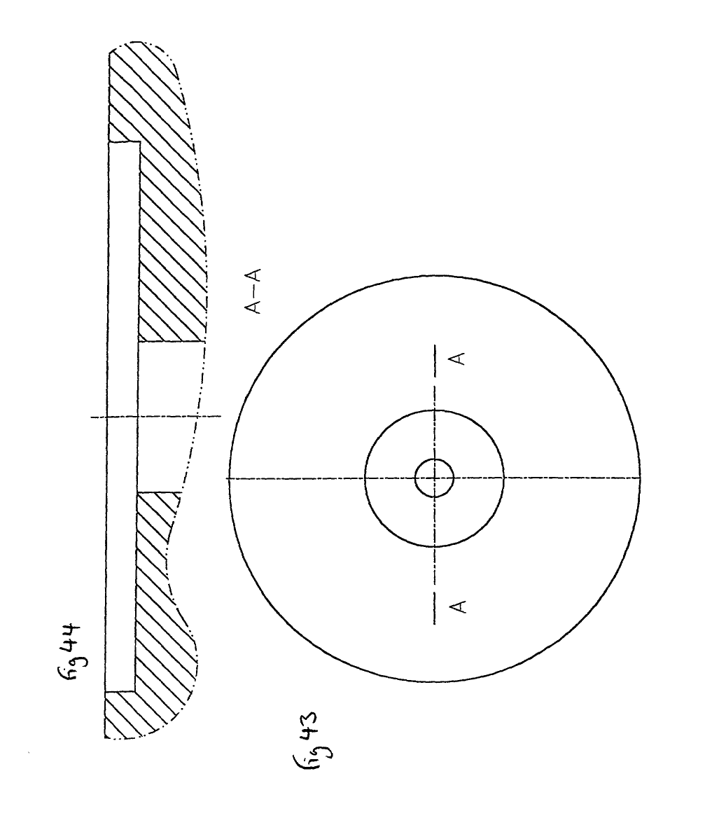

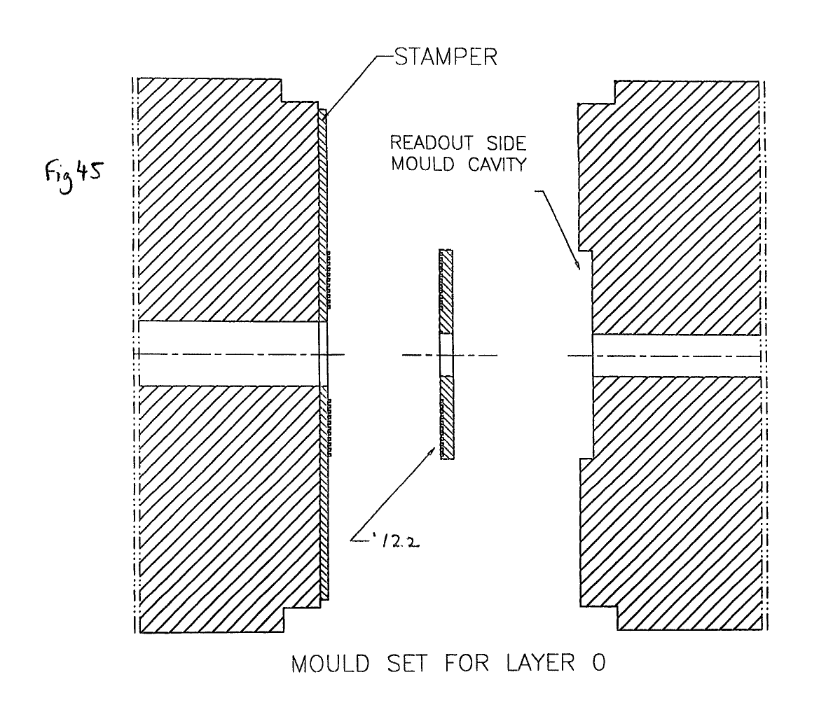

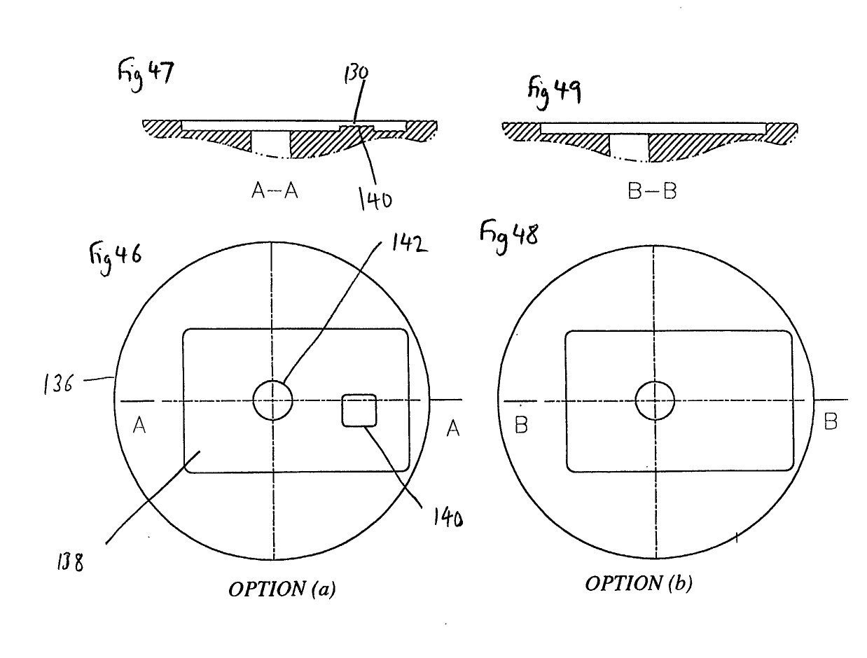

FIG. 44 shows an enlarged section A-A through FIG. 43;

FIG. 45 shows a stamper and mold for forming the DVD disk layer of the DVD of FIG. 40;

FIG. 46 shows a plan view of a mold for forming the smart card layer of the DVD of FIG. 40;

FIG. 47 shows a partial section A-A through FIG. 46;

FIG. 48 shows a mold for forming the smart card layer of the smart card DVD of FIG. 42 in accordance with the third aspect of the present invention.

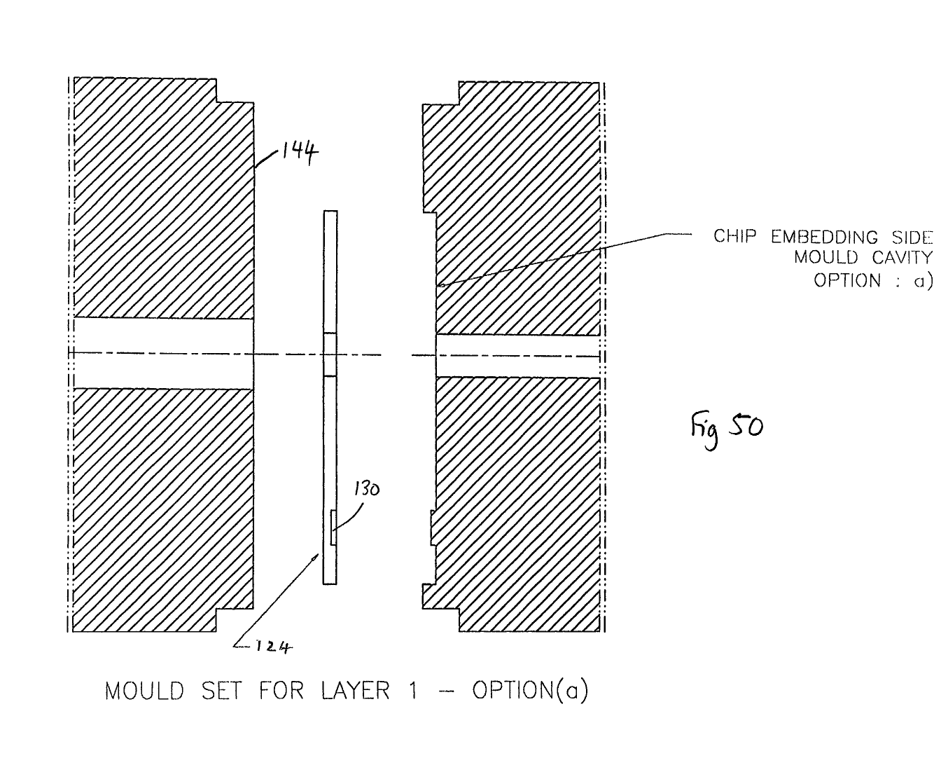

FIG. 49 shows a partial section B-B through FIG. 48;

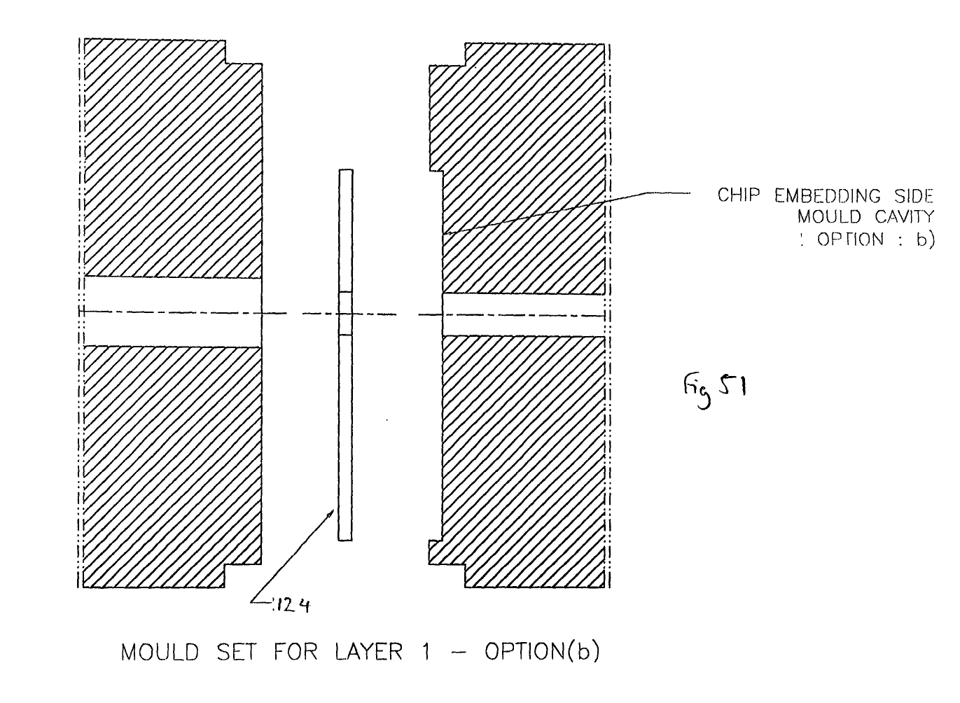

FIG. 50 shows a stamper and mold for forming a smart card layer of the DVD of FIG. 40;

FIG. 51 shows a stamper and mold for forming a smart card layer of the DVD of FIG. 42.

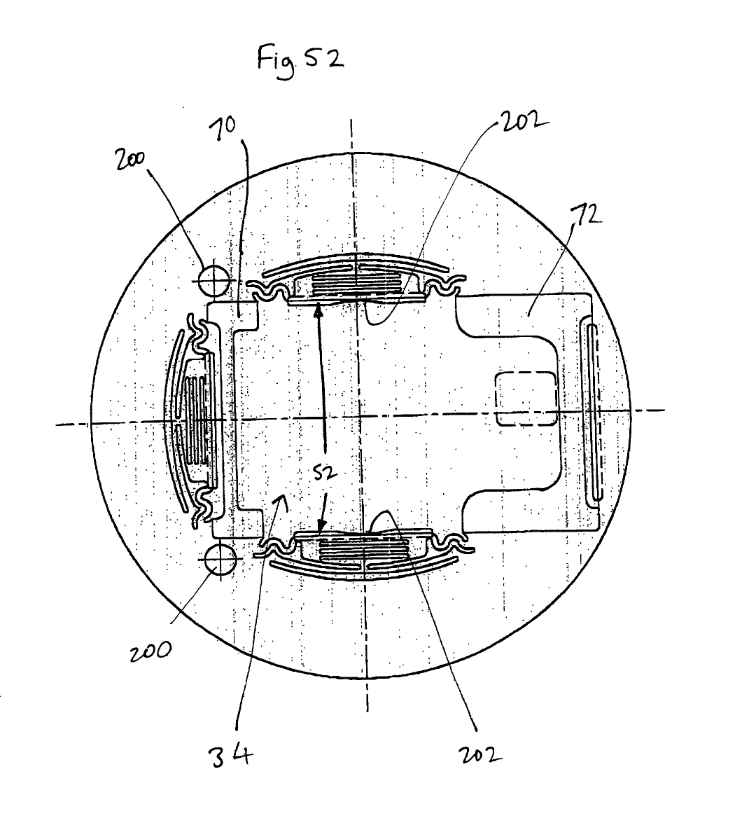

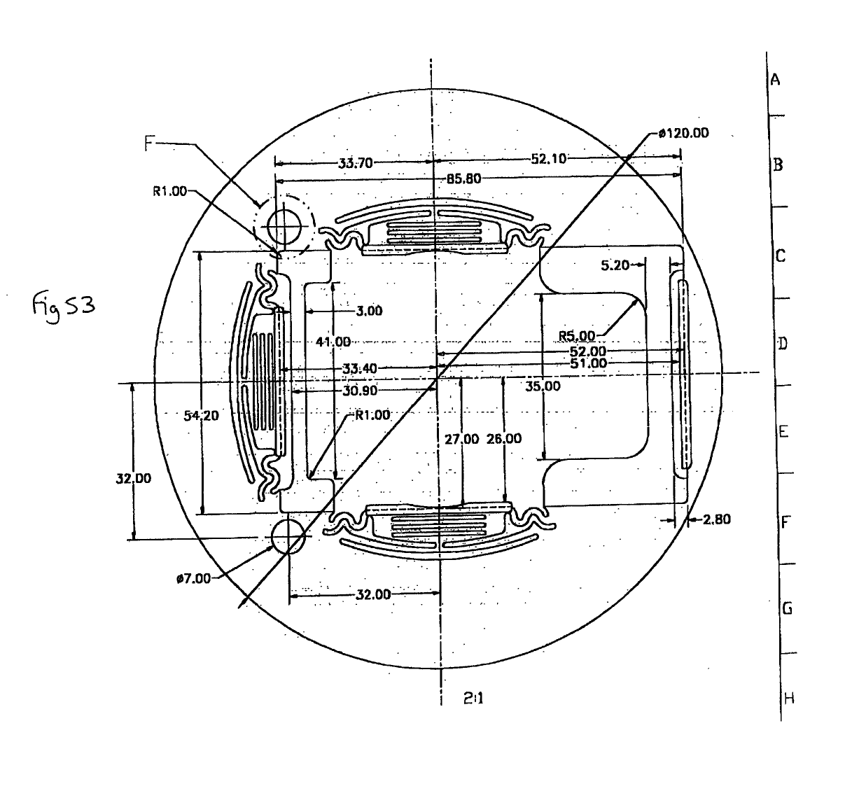

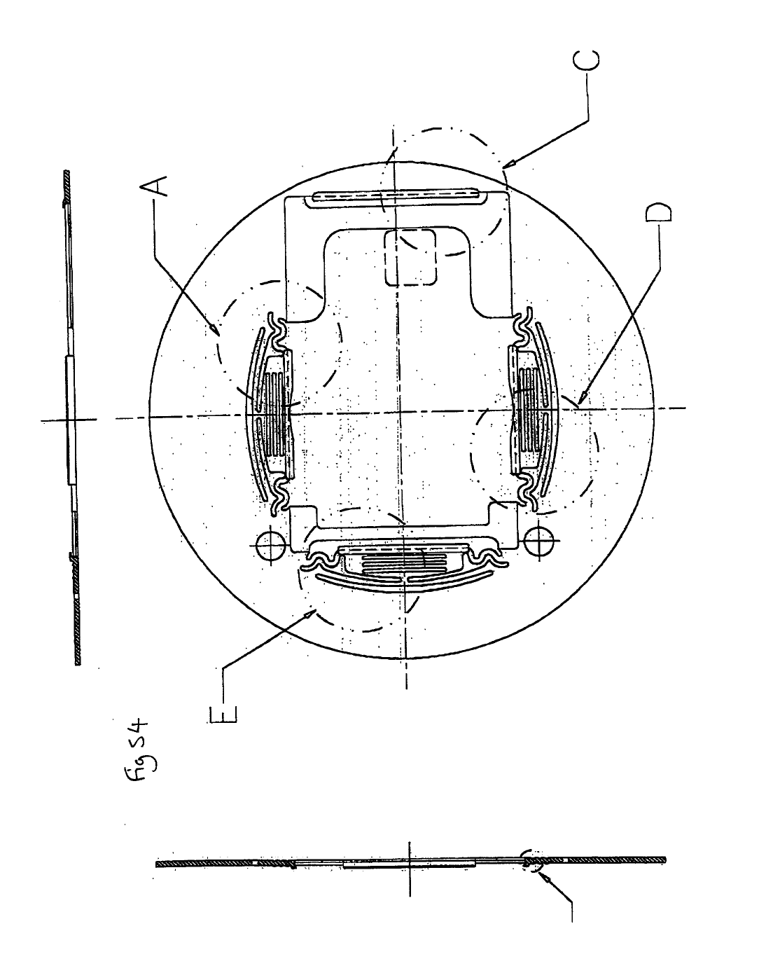

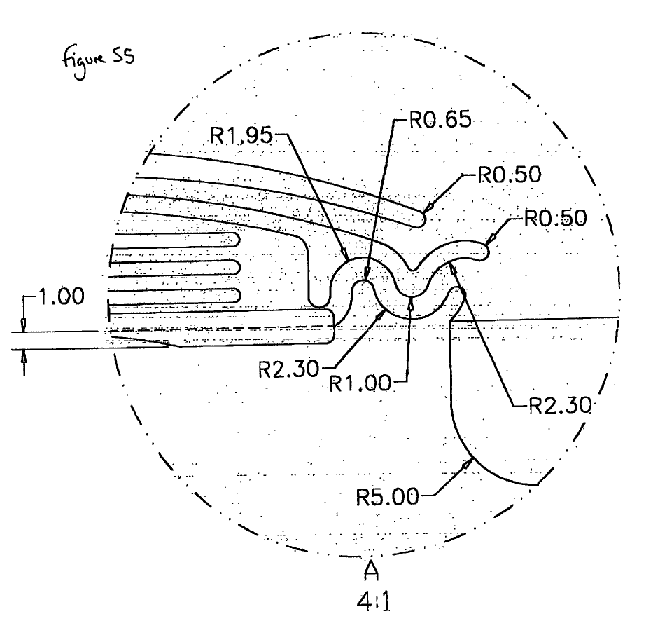

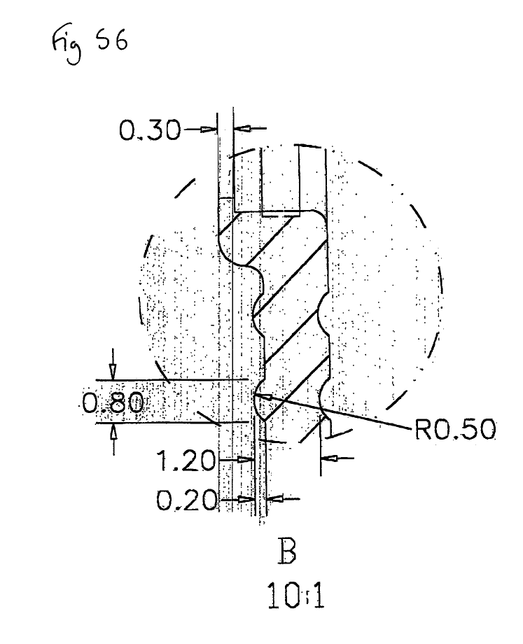

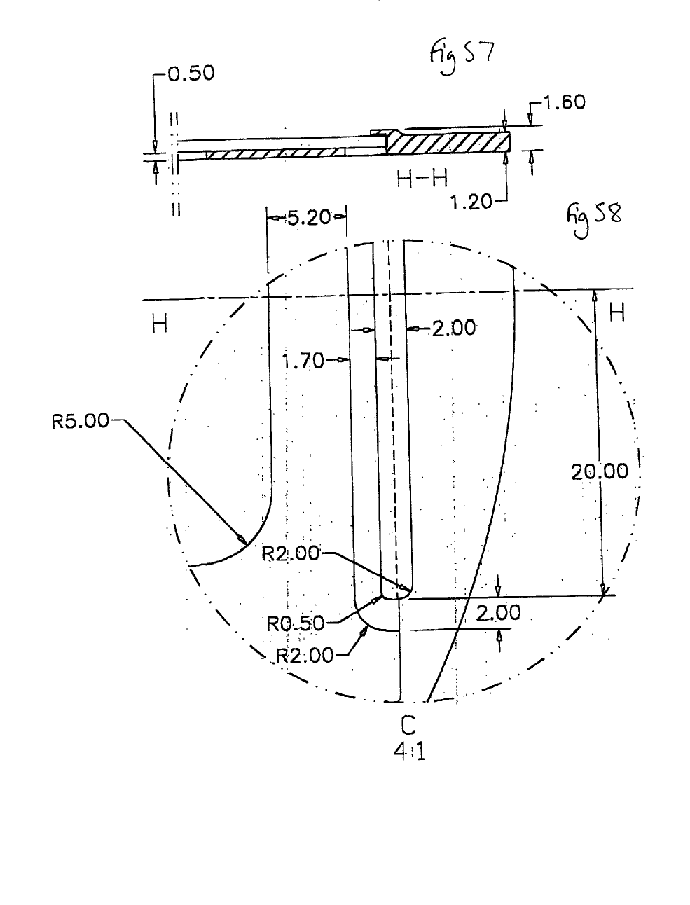

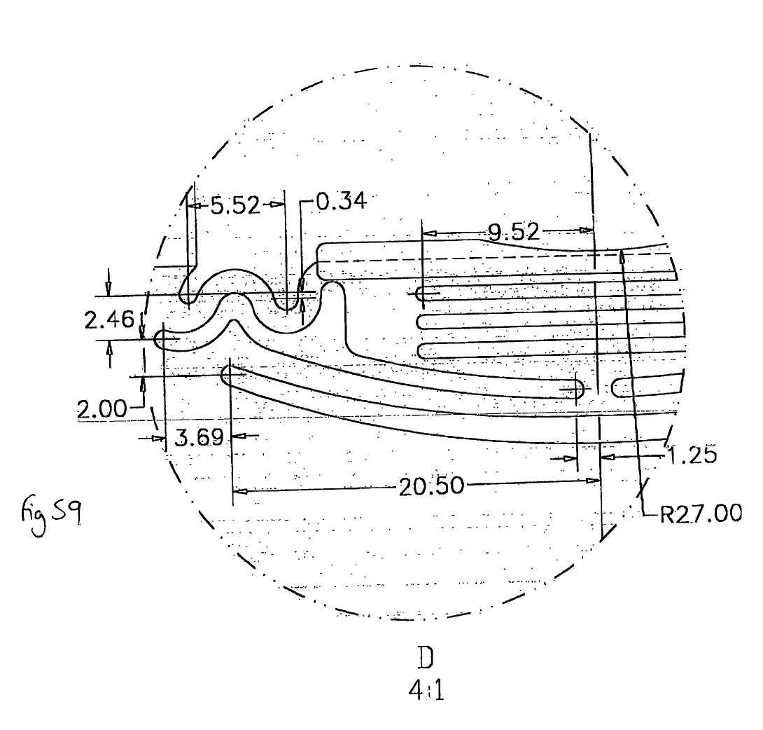

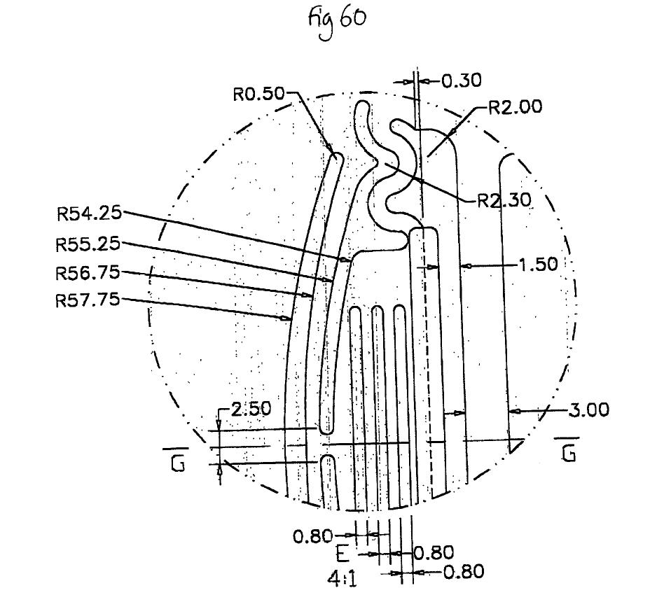

FIGS. 52 to 62 show a fourth embodiment of an adapter in accordance with the first aspect of the present invention; and

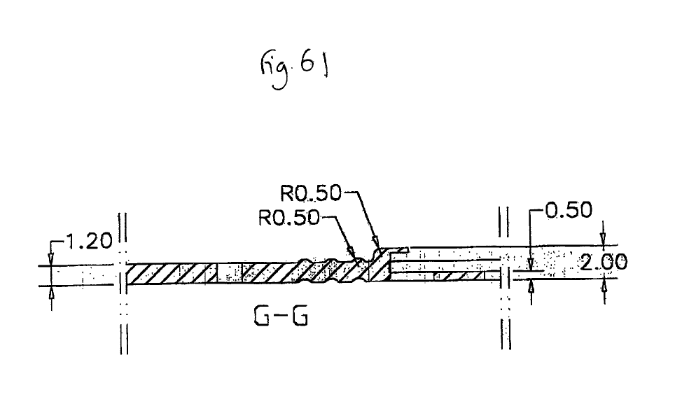

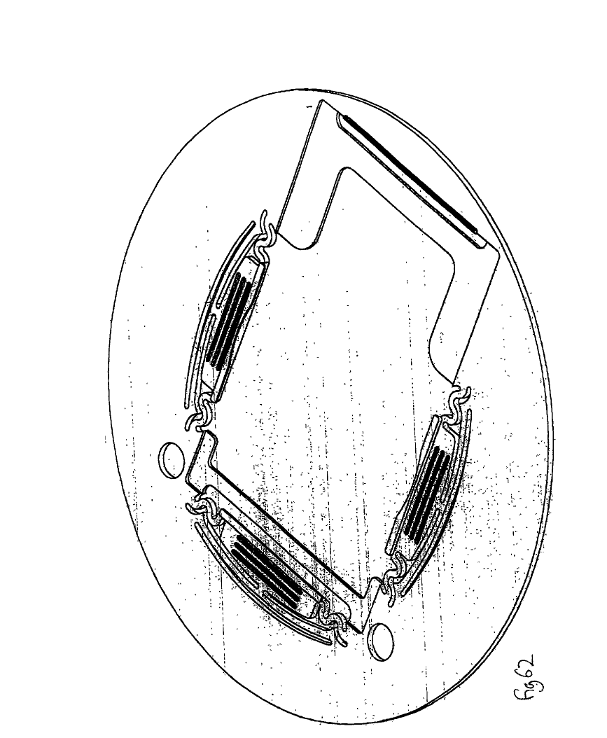

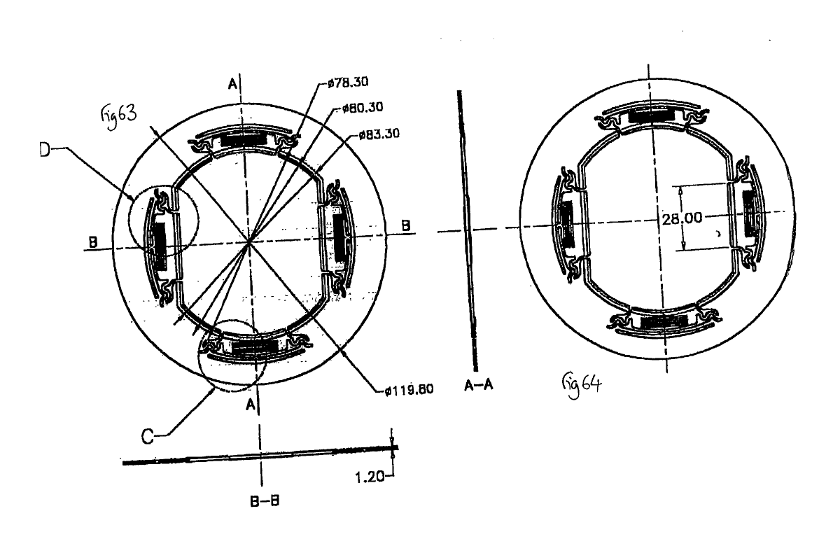

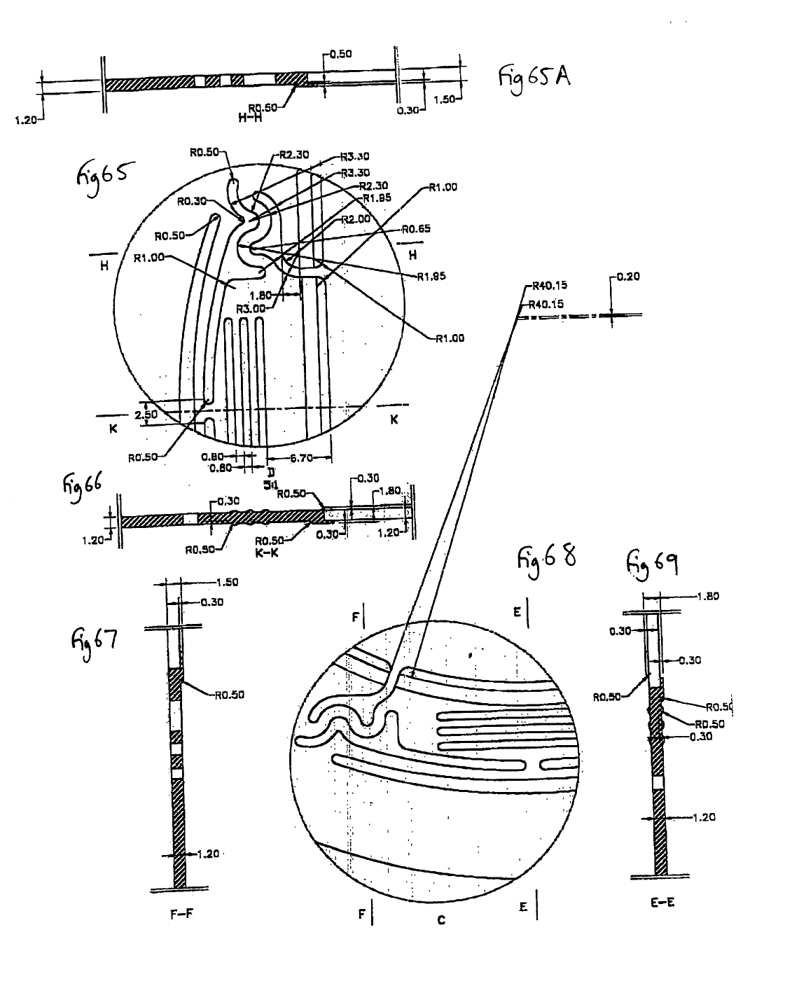

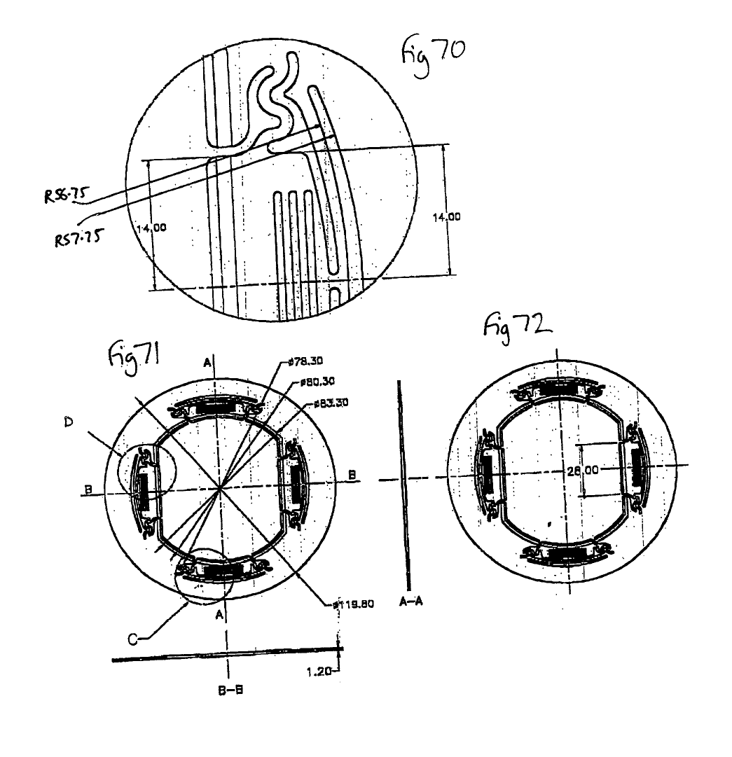

FIGS. 63 to 72 show a fifth embodiment of an adapter in accordance with the first aspect of the present invention.

Referring firstly to the prior art it is known that non-round shapes of optically readable carrier 10 can be provided. In the example of FIG. 1, the edge sectors 12 can be snapped off or cut away. However at least three outermost corners 14 are left that remain in positions on the perimeter 16 of the carrier 10. CD information is recorded on a central ring 18 of the carrier 10 so that snapping off or cutting out the edge sectors 12 does not affect the stored information 18 on the carrier 10.

Referring now to FIG. 2, a rectangular carrier 10 is shown, i.e. four sides of a circular carrier have been cut away. The diagonal dimension of the carrier 10 corresponds to the diameter of a conventional CD. The four corners 14 define four arcs of the same circle perimeter 16 (see FIG. 1).

Referring now to FIG. 3, the carrier 10 has an erratic shape. Information is again stored on a central portion or ring 18 of the carrier 10. Two knobs 20 are provided in suitable positions to provide two locating means for alignment of the carrier 10 in a drive tray. Typically, the knobs 20 will be spaced apart such that their outermost edges lie approximately 80 mm apart. More typically, more than two knobs are provided. A clamping area 19 is positioned radially inward of the information stored on the central portion 18, the clamping area 19 having a central aperture 21 for a spindle (not shown) of a CD player.

Referring now to FIG. 4, a credit card sized carrier 10, is shown. Again, the carrier 10 has information 18 recorded on it. The corners 22 of the carrier 10, and two of the edges 24 are rebated to define arcaate returned edges 26 for locating in the slot of a drive tray The arc diameter is approximately 8 mm.

In accordance with conventional CD technologies, the information is imprinted by way of a spiral track of depressions or pits in a highly reflective surface within the carrier. Further details, requirements and specifications for optically readable carriers have been published by Philips in a number of CD standard specifications, which have been co-developed with Sony, Kodak, JVC and Matsushita.

Details on DVD specifications are available from any of the following companies:

HITACHI, LTD. (Tokyo, Japan)

MATSUSHITA ELECTRIC INDUSTRIAL CO, LTD. (Osaka, Japan)

MITSUBISHI ELECTRIC CORPORATION (Tokyo, Japan)

PHILIPS ELECTRONICS N.V. (Eindhoven, The Netherlands)

PIONEER ELECTRONICS CORPORATION (Tokyo, Japan)

SONY CORPORATION (Tokyo, Japan)

THOMSON MULTIMEDIA (Paris, France)

E TIME WARNER INC. (New York, USA)

TOSHIBA CORPORATION (Tokyo, Japan)

VICTOR COMPANY OF JAPAN, LTD (Yokohama, Japan)

Referring now to FIG. 7, a first embodiment of an adapter 30 in accordance with the first aspect of the present invention is shown. The adapter 30 comprises a generally circular, planar body 32. In the central portion of the body 32 an aperture 34 is provided. Although this aperture 34 allows a central spindle (not shown), as generally used in CD players, and the like, to extend through the adapter, and therefore through an optically readable carrier seated therein, (not shown). Also, it reduces the weight of the adapter 30. However, the main purpose of the aperture 34 is to allow an optically readable surface of the carrier to be read on either side of the adapter.

In a preferred embodiment, the adapter is made of a plastics material.

Four carrier retaining means are provided for the body 32. The body material needs to be resilient so that the retaining means 36 can flex without breaking. The retaining means 36 each take the form of a retaining member mounted on two spring-arms 38. More spring arms can be provided, however. A carrier 10 to be seated in the adapter 30 engages with at least two of these retaining members, the resilience of the spring-arms 38 causing a bias against the carrier 10 to retain the carrier 10 on or in the adapter 30.

The retaining means 36 are provided in diametrically opposing pairs. The four retaining means 36, as shown, provide two such pairs. The two pairs are diametrically disposed at right angle to each other, although they could be otherwise arranged. The first pair is positioned at a first radius. The second pail is positioned at a second radius. By providing the two pairs at two different radii, two different sizes of rectangular carrier 10, for example, can be retained on the adapter, although only one at a time. Also, a balanced adapter is achieved by symmetrically positioning the retaining means. However, see the later embodiments for other methods of achieving a balanced combined adapter and carrier assembly.

As shown in FIG. 7, the retaining means 36 are formed in the planar body 32 by cutting out a portion of the body 32 thereby leaving the respective shapes of the spring arms 38 and the retaining members. However, retaining means of other forms, for example rotatable clips or snap fittable, removable retaining means, may instead be provided.

Referring, now to FIGS. 8 to 14, a second embodiment of an adapter 30 is shown in accordance with the first aspect of the present invention is shown. Although largely similar to the first embodiment, shown in FIG. 7, the Figures more clearly show various aspects thereof. Also, this second embodiment has an alternative retaining means design 36.

As shown in FIG. 8, the body 32 has a recessed area 40. As shown in FIG. 9, this recessed area 40 is substantially cross-shaped. At the end of each cross arm, a retaining means 36 is provided.

The cross-shape is formed of two superimposed, orthogonally arranged, rectangles corresponding to the two sizes of carrier 10 to be seated in the adapter 30.

The recessed area 40 corresponds with a raised area 42 at the rear of the adapter 30, as can be determined from the side projections of FIG. 9 and the enlargement of FIG. 10. This effectively corresponds to a pressing of the recess outwardly at the rear of the adapter. This is provided so that a carrier 10, when sitting within the adapter 30, is positioned such that in use the optically readable surface of the carrier 10 will be at the correct reading position on a drive tray, i.e. at a correct height relative to the reading (or writing) head. This raised area 42 is rounded (see FIG. 10) about its extremities to define a deeper portion of the adapter 30 bounded by dotted line 44 in FIG. 11.

The four retaining means 36 of this preferred embodiment are again integral with the body 32, formed of a retaining member 48 and spring-arms 38. However an additional spring-arm 46 is provided. The first pair of spring-arms 38 are serpentine. They allow flexure of the retaining member 48 in all planes, including longitudinal, i.e. stretching thereof. This allows the retaining member to remain flat even when the retaining member 48 is flexed out of plane with the body 32. The second retaining arm 46 is a joined pair of arms that provides stability to the retaining means from circumferential displacement. Additional strength to the retaining means (more attachment area to the body 32) and a return force against radial displacement of the retaining member 48 relative to the body 32 are also provided by the second retaining arm 46.

To facilitate radial displacement of the retaining member 48, gripping ribs 50 are provided on both sides of the retaining member 48. These ribs are clearly shown in FIG. 13. One rib 50 is shown in FIG. 10.

The retaining member 48 additionally has a ledge 52 provided at the leading edge thereof, i.e. its edge immediately adjacent the recessed area 40. This ledge 52 provides a catch to engage, in use, the outer side of a carrier 10, thereby holding the carrier 10 on both sides thereof to prevent the carrier 10 from failing out of the adapter 30. The outer side of the carrier 10 will generally be the side that contains the readable information 18. For this reason, the ledge 52 only projects a short distance, typically 0.5 mm, over the cross-shaped recessed area 40.

The ledge 52, as shown in FIG. 10, just like the raised area 42, is located in a position displaced outwardly from the plane of the body 32. As shown in FIGS. 9, 11 and 12, the ledge 52 resembles a moulding on the retaining member.

The dimensions of the preferred adapter 30 are shown in FIGS. 9 to 14 with the preferable tolerances stated. However, it will be appreciated that for optically readable carriers 10 of sizes other than those stated above, or described below, alternative dimensions for the adapter may be necessary.

Further, in place of the outermost shape of the adapter being a circle having a diameter of approximately 120 mm, the adapter may merely add to a carrier 10 stabilising means of the types described above with reference to the prior art, namely of the types described in DE19607565, for example having straight line edges; and HK1008469, for example having suitably positioned knobs.

Referring flow to FIGS. 15 to 26, there is shown a third embodiment of a adapter in accordance with the first aspect of the present invention. This adapter is designed to carry a single carrier having an off-set clamping area provided therein or thereon. Suitable carriers are shown in FIGS. 27, 28, 30, 39 and 40. The components and features of this third embodiment conform largely with those shown in the embodiment of FIG. 9. Therefore a detailed description of all the features will not be required. However, only three resiliently mounted retaining members 48 are provided. One is positioned for each of the long sides of the recessed area 40 and one is provided for one of the short sides thereof.

Each retaining member 48 is provided with a ledge 52, as before. However, discrete shelves 70, 72 are provided for seating a carrier within the recessed area 40. One of these shelves 72 is immediately adjacent the third retaining member 48. This retaining member 48 is positioned to engage, in use, with a short edge of a carrier.

The shelves 70, 72 lie in a plane extending parallel to the plane of the body of the adapter.

The radially innermost edge 74 (relative to the body of the adapter) of the first shelf 72 is arcuate, having a radial centre positioned at the centre C of the adapter (see FIG. 15). This allows a maximum amount of readable area 18 on a carrier retained within the adapter to be read by a reading device (not shown).

The second shelf 70 is positioned adjacent a fourth ledge 52 which is fixed and which is adapted to engage with a second short edge of a carrier. No resiliently mounted retaining member 48 is required for this ledge 52. One of the retaining members on the long sides might also be omitted and replaced with a fixed ledge. Other retaining means might alternatively be provided, as discussed for the earlier embodiments.

As in FIGS. 9 to 14, the preferred dimensions of the adapter are shown in some of FIGS. 15 to 26. These dimensions are all in millimetres. However, it will be appreciated that for carriers of different sizes and shapes, the shape of the recessed area 40, and/or the positions and shapes of the retaining members 48, may need to be appropriately shaped to conform to the shape of the carrier to be retained in the adapter.

Referring now to FIG. 26, it can be seen that the thickness of the two shelves 70, 72 are not the same. For a carrier having an off-set clamping area, the centre of mass will not correspond with the centre of the clamping area thereof. For this reason, it is necessary to acid some form of counterbalance or counterweight in either the carrier or the adapter so that during high speed rotation, such as would occur in a high speed CD drive or DVD drive, any vibration that would be caused by an imbalance can be minimised. By varying the thicknesses of the two shelves the counterbalance weight can be provided. A skilled person would have no difficulty in determining appropriate thicknesses of these shelves 70, 72 for the design of the carrier in question. Alternatively, a skilled person would have no difficulty in determining what counterweight to design into the smart card itself. A further alternative would be to mount a counterweight within the adapter.

Referring now to FIGS. 52 to 62, a fourth embodiment of an adapter in accordance with the first aspect of the present invention is shown. This embodiment is in most respects similar to the third embodiment, shown in FIGS. 15 to 26. However, the shelves 70, 72 have been reshaped and counterbalancing holes 200 have been provided.

The holes 200 remove weight from the adapter for counterbalance effect. The holes 200 could be positioned elsewhere on the adapter, or resized, depending on the extent and position of the imbalance needing correcting.

In the third embodiment, i.e. that shown in FIGS. 15 to 26, the thickness discrepancy (0.9 mm and 0.5 mm for the shelves 70 and 72, respectively) not only serves to provide a counterbalancing effect, but also serves to compensate a 2-step thickness of carrier (see the description relating to FIGS. 27 and 28, et al). The carrier has a 0.4 mm step. Therefore, the two shelves 70, 72 also have a difference in thickness of 0.4 mm. When the carrier is retained on the adapter with the readout side, i.e. that which has the thickness step, facing the shelves 70 and 72, the step will not create an off-plane seating of the carrier in the adapter. In this fourth embodiment, however, the thickness of the two shelves 70, 72 is equal (0.5 mm). Counterbalancing means is provided by, for example, the shape of the shelves 70 and 72. Again, however, the shelves are preferably shaped to avoid interfering with the data pickup from the optically readable surface. Further counterbalancing effect is also achieved, of course, by the holes 200.

Despite the shelves having the same thickness, this fourth embodiment can also be used with the readout side of the carrier facing the shelves 70, 72. A small difference in thickness (0.4 mm) of a smart card carrier should not cause a significant problem.

To increase the optically readable area through the aperture 34, the two ledges 52 on the long sides of the recessed area 40 have an arcuate rebate 202 provided.

Experiments reveal, however, that the carrier should preferably be retained on the adapter with the non-readout side facing the shelves 70 and 72. This configuration is preferable because the other configuration (i.e., with the readout side facing the shelves 70 and 72) may cause damage to the laser head. The adapter may hit the laser head since the bottom-most part of the adapter would necessarily be closer to the laser head than the carrier due to the ledges 52.

Referring now to FIGS. 63 to 72, a fifth embodiment of an adapter in accordance with the first aspect of the present invention is shown. This fifth embodiment again comprises many features common to previous embodiments and therefore needs no detailed description.

It is designed to carry an optically readable carrier of a substantially round shape but having sectors cut from opposite sides thereof, thereby having two straight, parallel edges and two opposed, co-arcuate edges, having a preferred diameter of 80 mm.

This fifth embodiment therefore is an adapter that adapts a small optically readable carrier (preferably one that will not stabilise itself in a drive tray) for playing in a 120 mm tray of a player. It will therefore enable such a carrier to be played, for example, in a slot loading device that cannot handle non-120 mm disks.

It will be appreciated that adapters in accordance with the present invention could be made to carry many other shapes of optically readable carrier, not just those shown herein, e.g irregular shapes.

It should be noted that because of the tolerances imposed by the licensors in the field of CD, DVD and smart card technologies, the size of the relevant components are pre-defined so as to allow components manufactured by one manufacturer to be compatible with other equipment produced by another manufacturer, The Figures therefore show specific size requirements and tolerances for them. However, as technologies change, it will be appreciated that different dimensions may become more appropriate.

Referring now to the second and third aspects of the present invention, FIGS. 5 and 6 show first and a second embodiments of a carrier in accordance therewith.

Referring first to FIG. 5, the carrier 10 is substantially credit card shaped and sized. IT is approximately 1.2 mm thick, 85.6 mm long and 54 mm wide.

Referring to FIG. 6, the carrier 10 is slightly longer at 95 mm.

Both sides of both embodiments are flat up to the edges, except for the extreme edges thereof which are slightly rounded to dull them (these carriers will often be handled by users). Tie carriers 10 have a central aperture 54 into which a drive spindle, in use, will extend. Around the aperture, spacing portions 56 (including a clamping, area) are provided. A ring 58 is provided, corresponding to a ring found on conventional CDs, which may include etched writings (not shown), which is often copyright information. Outside this there is the area 18 for receiving the optically readable information. Present technology imprints the information by way of a spiroid track. Therefore the information area 18, in practice, is restricted to a ring.

The carriers 10 can be double or single sided.

A metallic or magnetic strip can be positioned in or on the carrier. This strip cart be for carrying non-optically readable data. For example a magnetic strip can be used to contain credit card details.

A smart card chip can also, or alternatively, be embedded into or provided on the carrier 10.

The longer length of the carrier 10 shown in FIG. 6, although not essential for making carriers in accordance with the present invention, provides a larger space for fitting a smart card chip to the carrier 10 without interfering with the information ring 18. The aperture 54 and the spacing portion 56 (e.g. clamping area 19) in the centre of the carrier 10 occupy a portion of the carrier 10 that has conventionally been used in credit cards for fitting of a smart card chip. By making the carrier longer, the chip can be fitted to the carriers 10 of the present invention at the conventional distance from the edge of the carrier 10 without repositioning the clamping area on the card. This allows the chip to be read on the carrier 10 of the present invention by conventional smart card readers However, non-contact smart cards also exist. These comprise chips that communicate using electromagnetism and an antenna built into the chip. Such non-contact smart cards need not have their chips positioned in any particular position thereon, other than in a position that would not interfere with the optically readable portion and the clamping area 19 thereof.

Further information on smart cards is given in various International Standards, in particular ISO/IEC 7810 and ISO/IEC 7816, which relate to contact type smart cards.

Although not shown in the representations, magnetic strips and/or smart card chips are, in themselves, conventional in the art of credit cards. A skilled person would therefore have no difficulty in embedding such items into the optically readable carriers 10 of the present invention.

The carriers 10 of the present invention are sized to fit into adapters 30 in accordance with the first aspect of the present invention. As such, the present invention enables optically readable carriers 10 to be designed without the constraints of the prior art non-round carriers 10. There is no longer the requirement to include either knobs 20, returned edges 26, or the like. Neither is there the requirement for the carrier to be of a size having parts thereof, on either a face or an edge thereof, suitable for, in use, fitting within a slot of a tray of a drive for stabilising the carrier within the tray.

The present invention provides carriers 10 that can be read by a computer both optically using the optically readable information, and otherwise, for example using the magnetic strip or a smart card chip. This enables various methods of electronic transactions to be used with one card, e.g. for e-commerce, electronic cash transfers or payments.

The elimination of the knobs in prior art devices is also important because it enables the optically readable carrier 10 also to be used as a true credit card (swipeable) and it is easily carriable in a wallet.

The embedding of magnetic strips or smart cards chips into the carriers 10 of the present invention can be achieved by conventional methods known to a person skilled in the art. However, FIGS. 27 to 51 show various smart card CDs or DVDs, and various methods of manufacture that have been developed for manufacturing them.

Many of the Figures include dimensions thereon. These dimensions are provided to enable CDs or DVDs to be manufactured that meet certain Standard requirements for both smart cards and CDs or DVDs, respectively.

Although smart card chips of any type may be provided in or on CDs and DVDs, i.e. with or without contacts, this invention is primarily concerned with smart card chips of the contact type, i.e. having gold contacts for engaging with sprung contacts, or the like, provided in a smart card reader. For this reason, the position of the smart card chip on the CD or DVD is important to enable the chip to be positioned, in use, in a smart card reader in the appropriate manner.

It should be noted, however, that if non-contact smart card chips are to be used, the position of the smart card chip on the CD or DVD becomes less important. As long as it does not interfere with the portion of the CD or DVD that is used to record the optically readable data, the smart card chip can be positioned anywhere since non-contact smart cards are read using an electromagnetic signal that can be effective, for example, at a range of perhaps half a meter.

The International Standards for smart cards with contacts are set out in at least ISO/IEC 7810 (identification cards) and ISO/IEC 7816 (integrated circuit cards with contacts). These Standards provide for standard sizes of smart cards, e.g. having a thickness of 0.76 mm±0.08 mm. The standard location for the contacts leading from the smart card micro-controller are set out also in ISO/TEC 7816. Although these sizes are preferred for compatibility with other manufacturers' equipment, the sizes are not essential.

Smart cards are versatile in application. A common application is for electronic payment in which certain amounts of money are deducted from the card by transmitting the transaction amount in digital form. In electronic payments on the internet, for example, instead of transmitting, account and/or password information over the internet, only the mount of the transaction needs to be transmitted. This gives enhanced security over payment since it is possible to keep account information secret.

When smart card issuers issue smart cards, they would generally like also to issue promotional and/or marketing materials. For example, videos showing new products or services may be desirable and/or software for accessing certain information may be required. In theory, such materials and software can also be stored in a smart card's micro-controller. However, in practice this is not preferable because of various constraints such as cost. For this reason by combining both current CD and/or DVD technology and smart card technology in one unit, costs can be reduced without comprising the amount of the information available. IT should be noted that smart card micro-controllers can handle changing information, whereas CDs tend to be single write (ROM) only. Where the information involved is static information, i.e. information that will not change, CD technology is ideal for making such recordals.

The size requirements of the readable portion of a CD or DVD are set out by licensors such as Philips. CD and DVD technology is essentially a licensed technology from them. For this reason, it is generally important, although not essential, that CDs are manufactured to the following specifications:

(i) Read out system: track shape: 1 spiral; no track interruption in information area.

(ii) Centre hole diameter: 15±0.1 mm

(iii) Thickness of the information area: 1.2+0.3 or −0.1 mm

(iv) Clamping area: 26<D<33 mm

(v) Thickness of clamping area: 1.2+0.3/−0.1 mm

(vi) Recorded area:

(a) Staring diameter of program area: 50+0/−0.4 min

(b) Maximum starting diameter of lead-in area: 46 mm

(c) Minimum outer diameter of lead-out area; outer diameter of program area plus 1 mm

and preferably (d) Maximum diameter of program area: 52.4 mm

Referring flow to FIG. 27, the smart cards in accordance of the present invention comprise a body portion having two separate thicknesses. The first portion, the CD portion 200, has a thickness of approximately 1.2 mm. This is in accordance with the standard requirements for CDs. The second portion, smart card portion 202, however, has a thickness of 0.8 mm. This is in accordance with the standard requirements for smart cards. A line 76 shows the border between these two portions 200, 202.

FIG. 28 shows another example of a smart card in accordance with the present invention. In this embodiment, the line 76 defining the border between the two portions 200, 202 is curved.

In both of these embodiments the smart card 78 is shown having contacts 77. According to ISO/IEC 7816, there should be 8 contacts.

Referring now to FIG. 29, a prior art smart card is illustrated. As can be seen, the smart card chip 78 is positioned in substantially the same position as in the smart cards in accordance with the present invention. However, the card has a single thickness (see FIG. 29A). Nevertheless, smart card readers in the art should still be able to read smart cards in accordance with the present invention since the leading edge of the smart card is of the correct thickness, and the card may not need to be fully inserted into the reader.

Referring now to FIGS. 30 and 30a there is shown a credit card sized carrier which meets the specification set down by Philips for compact discs.

The carrier 100 comprises a clamping area 102, a lead in and table of content area 104, a programme area 106 and a lead out area 108. The clamping area 102 has a minimum diameter of 33 mm. The lead in and table of content area 104 has a outer diameter of between 46 and 49.6 mm. The programme area has an outer diameter of between 49.6 and 52.4 mm. The lead out area has an outer diameter of between 52.4 and 53.4 mm. The card has a length and width of approximately 85.6 by 54 mm, respectively. A central hole 21 is provided inside the clamping area for a spindle of compact disc player. As can be seen in FIG. 30A, the thickness of the compact disc is approximately 1.2 mm. These dimensions meet the requirements of the Standards set by, for example, Philips.

Referring now to FIGS. 39 to 39A, a DVD in accordance with the International Standards is shown.

As can seen, the dimensions are largely the same as for the compact disc However, the card is formed from two layers. Further, the lead-in and table of contents area 104 has a outer diameter of between 45.2 and 48 mm. Further, the programme area 106 has an outer diameter of between 48.0 and 52.4 millimetres. Yet further, the clamping area on the DVD is generally larger. It is achieved by making the maximum inner diameter of the clamping area 22 mm rather than 26 mm. The thickness of the DVD is approximately 1.4 mm, although thicknesses in the range of 1.2+0.3/−0.06 mm generally meet Standard requirements.

Referring now to FIGS. 31 to 34, there is shown a stamper and mold assembly for forming a molded carrier in accordance with the embodiment shown in FIG. 27, with an area for accepting a smart card on the optically readable side thereof. A thinner area 110 is formed in that surface for the smart card part thereof. This is therefore a 2-step thickness. By forming the 2-step thickness in a single molding step, a strong card will be formed. However, the thinner area could be formed by milling a thinner area into a single thickness sheet.

The molding process is otherwise conventional. As can be seen in FIG. 32, the thinner area 110 is further recessed to form a nest 112 for sitting therein a smart card chip.

Referring now to FIG. 35, an alternative method of forming the carrier of the present invention is shown. In this method, a similar stamper and mold assembly is provided. However, there is no nest 112 for a smart card chip. In this embodiment, a smart card chip would preferably be positioned on the opposite side of the card to the previous example. For this purpose, a nest for the smart card may be provided in the opposite surface to the readable surface on the disk, for example, by an additional milling step. The nest is not shown. Of course, the nest could be milled on either surface.

Referring now to FIG. 40, a DVD smart card device is shown. The DVD smart card 120 comprises two layers 122, 124. These layers are shown separated in FIGS. 41 and 42. The first layer 122 comprises the optically readable part of a DVD carrier. Its form is conventional, although small with an outermost diameter of 54 mm. The second layer 124 is substantially credit card shaped. Its thickness is 0.8 mm corresponding with the thickness requirements for smart cards. A smart card chip 126 is provided thereon in the position required by the International Standard. By joining the DVD layer 122 with the credit/card layer 124, the DVD carrier is completed to a conventional thickness.

As can be seen in FIG. 41, the first layer 122 is bonded to the second layer 124 by a bonding layer 125. The use of a bonding agent in the formation of duel layer DVDs is conventional in the art.

The two discrete layers can be formed using similar molding techniques as discussed above.

FIGS. 43 to 51 show stamper and mold assemblies for the various components

As shown in FIGS. 43 to 45, forming the first layer 122 comprising a DVD readable layer involves pressing a stamper against a mold cavity as before. This forms a disc. The mold cavity is shown in FIG. 43 (and in an enlarged section in FIG. 44).

Regarding the second layer 124, this can be formed in two ways. The first option (a), shown in FIGS. 46, 47 and 50 involves the pressing of a layer 124 having a nest 130 for a smart card chip. The second, option (b), shown in FIGS. 48, 49 and 51 does not have a nest for a smart card chip. If a smart card chip needs to be added to this second layer 124, it can be provided in conventional ways such as by milling a nest 130 in an additional step. The nest can be provided in this way on either side of the layer. The mold shown in FIGS. 46 and 47 comprises a circular outer shaped block 136 having a mold cavity 138 with an upwardly extending pan 140 therein for forming the nest 130. A hole 142 is provided to allow the central aperture for the finished smart card CD/DVD carrier to be formed in the layer, for example by punching through the hole in the stamper 144, shown in FIG. 50, during the molding/stamping process.

The present invention has been described above purely by way of example. It should, be noted that modifications in detail may be made within the scope of the invention. In particular, the disclosure above is not limited to adapters suitable for two carrier sizes. The present invention also contemplates adapters suitable for more than two carrier size. Also, the adapter could be of 80 mm outermost diameter for stabilising smaller carriers.

1. An adapter for a non-round optically readable carrier, the adapter comprising a ledge formation adapted to seat the optically readable carrier, whereby, in use, a non-round optically readable carrier is retained in a seated position on the ledge formation.

2. An adapter according to claim 1, wherein a non-round, functional surface is provided for abutting an edge of the carrier or part thereof.

3. An adapter according to claim 2, wherein the functional formation is sized to retain the carrier by means of an engagement fit.

4. An adapter according to any one of the preceding claims, wherein the adapter is provided with one or more retaining means for retaining the carrier on the ledge formation.

5. An adapter according to claim 4, wherein the retaining means is one or more resilient clamping means.

6. An adapter according to claim 4, wherein the retaining means is a resilient clip.

7. An adapter according to any one of the preceding claims, wherein the adapter comprises a planar member having an edge thickness and outermost diameter in accordance with a conventional round optically readable carrier.

8. An adapter according to any one of claims 1 to 7, wherein the adapter has a non-round shape, and means for locating the adapter in a tray of a CD player comprising one or more of appropriately positioned corners, appropriate diagonal dimensions or knobs/arcuate returned edges.

9. An adapter according to any one of the preceding claims, wherein the adapter is for a substantially rectangular optically readable carrier

10. An adapter according to claim 9, wherein the adapter is for a credit card shaped optically readable carrier.

11. An adapter according to any one of the preceding claims, wherein the adapter is for two or more different sizes and/or shapes of optically readable carrier.

12. An adapter according to claim 11, wherein the adapter comprises two or more sets of retaining means, the first set adapted to retain an optically readable carrier of one size and the other set adapted to retain an optically readable carrier of a second size.

13. Au adapter according to claim 11, wherein the two separate sets of retaining means may have their own associated ledge formations.

14. An adapter according to any one of the preceding claims, wherein the adapter is provided with a well for accepting the optically readable carrier therein.

15. An adapter according to claim 13, wherein the well is generally cross-shaped, the cross being defined by two superimposed, orthogonally arranged, different sized and/or shaped, rectangles.

16. An adapter according to any one of the preceding claims, wherein the ledge formation is offset from a central point of the adapter.

17. An adapter according to any one of the preceding claims provided with a counterbalancing means.

18. A non-round, substantially flat, optically readable carrier.

19. An optically readable carrier incorporating non-optical means for interacting with a further apparatus.

20. An optically readable carrier according to claim 19, wherein the non-optical means is a magnetic strip.

21 An optically readable carrier according to claim 19 or 20, wherein the non-optical means is a smart card chip.

22. An optically readable carrier according to any one of claims 18 to 21, wherein the corners thereof are rounded, but are not defined by co-arcuate arcs.

23. An optically readable carrier according to any one of claims 18 to 22, wherein the carrier is a double sided optically readable carrier.

24. An optically readable carrier according to any one of claims 18 to 23, wherein the optically readable surface extends substantially to at least two edges of the carrier.

25. An optically readable carrier according to any one of claims 18 to 24, wherein the carrier is of a shape having no part thereof, on either a face or all edge thereof, suitable for, in use, fitting within a slot of a tray of a drive for stabilising the carrier within the tray.

26. An optically readable carrier according to any one of claims 18 to 24, wherein the optically readable carrier is substantially rectangular.

27. An optically readable carrier according to claim 26, wherein the carrier is about 1.2 mm thick, 85.6 mm long and 54 mm wide.

28. An optically readable carrier according to claim 26, wherein the optically readable carrier is about 1.2 mm thick, 95 mm long and 54 mm wide.

29. An optically readable carrier according to any one of claims 18 to 28, wherein the carrier is a credit or debit card.

30. An optically readable carrier according to any one of claims 19 to 29 comprising a clamping area off-set from the middle of the carrier.

31. An optically readable carrier according to any one of claims 19 to 30 comprising a counterbalance means.

32. An optically readable carrier according to any one of claims 18 to 31, wherein both sides of the carrier are substantially smooth, without grooves, knobs or the like, other than a spindle aperture and a clamping area.

33. An optically readable carrier according to any one of claims 18 to 32 comprising an optically readable area having a first thickness and a smart card area of a second thickness, the smart card area having fitted therein or thereon a smart card chip of the contact type.

34. An optically readable carrier according to any one of claims 18 to 33 adapted to fit into the adapter of any one of claims 1 to 17.

35. An adapter of any one of claims 1 to 17, adapted to retain an optically readable carrier according to any one of claims 18 to 33.

36. An adapter substantially as hereinbefore described with reference to the accompanying drawings.

37. An optically readable carrier substantially as hereinbefore described with reference to the accompanying drawings.

38. A credit or debit card substantially as hereinbefore described with reference to the accompanying drawings.

39. A smart card substantially as hereinbefore described with reference to the accompanying drawings.
